(19) United States
(12) Patent Application Publication
(10) Pub. No.: US 2022/0132430 A1
(43) Pub. Date: Apr. 28, 2022

(54) BASE STATION APPARATUS, TERMINAL APPARATUS, COMMUNICATION METHOD, AND INTEGRATED CIRCUIT

(71) Applicants: Sharp Kabushiki Kaisha, Sakai City, Osaka (JP); FG Innovation Company Limited, Tuen Mun, New Territories (HK)

(72) Inventors: Masayuki HOSHINO, Sakai City (JP); Shohei YAMADA, Sakai City (JP); Hiroki TAKAHASHI, Sakai City (JP); Liqing LIU, Sakai City (JP); Hidekazu TSUBOI, Sakai City (JP)

(21) Appl. No.: 17/429,387

(22) PCT Filed: Feb. 14, 2020
(86) PCT No.: PCT/JP2020/005750

§ 371 Date: Aug. 9, 2021

(30) Foreign Application Priority Data
Feb. 14, 2019 (JP) 2019-024507

(51) Int. Cl. H04W 52/14; H04W 52/24; H04W 52/32; H04L 5/00

(52) U.S. Cl. CPC H04W 52/143; H04L 5/0051; H04W 52/325; H04W 52/242

(57) ABSTRACT

A communication method for a terminal apparatus includes receiving a higher layer configuration including a parameter for a sounding reference signal and a parameter to be applied to transmit power control; transmitting the sounding reference signal, one or multiple parameters for one or multiple path loss reference reference signals being included in the parameter to be applied to the transmit power control, at least one of a sounding reference signal resource set ID and a sounding reference signal resource ID being included in the parameter for the sounding reference signal; specifying a first path loss reference reference signal by using a sounding reference signal resource set ID; and calculating a downlink path loss estimation by using the first path loss reference reference signal and performing the transmit power control on the sounding reference signal by using the downlink path loss estimation.

### TECHNICAL FIELD

The present invention relates to a base station apparatus, a terminal apparatus, a communication method, and an integrated circuit. This application claims priority based on JP 2019-24507 filed on Feb. 14, 2019, the contents of which are incorporated herein by reference.

### BACKGROUND ART

Technical studies and standardization of Long Term Evolution (LTE)-Advanced Pro and New Radio (NR) technology, as a radio access scheme and a radio network technology for fifth generation cellular systems, are currently conducted by the Third Generation Partnership Project (3GPP) (NPL 1).

The fifth generation cellular system requires three anticipated scenarios for services: enhanced Mobile BroadBand (eMBB) which realizes high-speed, high-capacity transmission, Ultra-Reliable and Low Latency Communication (URLLC) which realizes low-latency, high-reliability communication, and massive Machine Type Communication (mMTC) that allows a large number of machine type devices to be connected in a system such as Internet of Things (IoT).

### CITATION LIST

### Non Patent Literature

NPL 1: RP-161214, NTT DOCOMO, “Revision of SI: Study on New Radio Access Technology”, June 2016

### SUMMARY OF INVENTION

### Technical Problem

An object of an aspect of the present invention is to provide a base station apparatus, a terminal apparatus, a communication method, and an integrated circuit that enable efficient communication in a radio communication system as that described above.

### Solution to Problem

(1) In order to achieve the above-described object, aspects of the present invention provide the following measures. Specifically, a communication method according to an aspect of the present invention is a communication method for a terminal apparatus, the communication method including: receiving a higher layer configuration including a parameter for a sounding reference signal and a parameter to be applied to transmit power control; transmitting the sounding reference signal, wherein one or multiple path loss reference reference signal parameters are included in the parameter to be applied to the transmit power control, at least one of a sounding reference signal resource set ID or a sounding reference signal resource ID is included in the parameter for the sounding reference signal, a first path loss reference reference signal is identified by using the sounding reference signal resource set ID, and a downlink path loss estimation is calculated by using the first path loss reference reference signal to perform the transmit power control on the sounding reference signal by using the downlink path loss estimation.

(2) In a communication method according to an aspect of the present invention, in a case that a higher layer configuration received includes information related to a panel ID, a second path loss reference reference signal is identified by using a combination of the panel ID and the sounding reference signal resource ID, and a downlink path loss estimation is calculated by using the second path loss reference reference signal and transmit power control is performed on the sounding reference signal by using the downlink path loss estimation.

(3) A communication method according to an aspect of the present invention is a communication method for a base station apparatus, the communication method including: transmitting, to a terminal apparatus, a higher layer configuration including a parameter for a sounding reference signal and a parameter to be applied to transmit power control; and receiving the sounding reference signal transmitted from the terminal apparatus, wherein one or multiple path loss reference reference signal parameters are included in the parameter to be applied to the transmit power control, at least one of a sounding reference signal resource set ID or a sounding reference signal resource ID is included in the parameter for the sounding reference signal, and the sounding reference signal is a signal obtained by calculating, by the terminal apparatus, a downlink path loss estimation by using a first path loss reference reference signal identified based on the sounding reference signal resource set ID and performing, by the terminal apparatus, the transmit power control by using the downlink path loss estimation.

(4) A terminal apparatus according to an aspect of the present invention is a terminal apparatus including: a receiver configured to receive a higher layer configuration including a parameter for a sounding reference signal and a parameter to be applied to transmit power control; and a transmitter configured to transmit the sounding reference signal, wherein one or multiple path loss reference reference signal parameters are included in the parameter to be applied to the transmit power control, at least one of a sounding reference signal resource set ID or a sounding reference signal resource ID is included in the parameter for the sounding reference signal, a first path loss reference reference signal is identified by using a sounding reference signal resource set ID, and a downlink path loss estimation is calculated by using the first path loss reference reference signal and the transmit power control is performed on the sounding reference signal by using the downlink path loss estimation.

(5) A base station apparatus according to an aspect of the present invention is a base station apparatus including a transmitter configured to transmit, to a terminal apparatus, a higher layer configuration including a parameter for a sounding reference signal and a parameter to be applied to transmit power control; and a receiver configured to receive the sounding reference signal transmitted from the terminal apparatus, wherein one or multiple path loss reference reference signal parameters are included in the parameter to be applied to the transmit power control, at least one of a sounding reference signal resource set ID or a sounding reference signal resource ID is included in the parameter for the sounding reference signal, and the sounding reference signal is a signal obtained by calculating, by the terminal apparatus, a downlink path loss estimation by using a first path loss reference reference signal identified based on the sounding reference signal resource set ID and performing, by the terminal apparatus, the transmit power control by using the downlink path loss estimation.

(6) An integrated circuit according to an aspect of the present invention is an integrated circuit mounted in a terminal apparatus, the integrated circuit including a receiving unit configured to receive a higher layer configuration including a parameter for a sounding reference signal and a parameter to be applied to transmit power control; and a transmitting unit configured to transmit the sounding reference signal, wherein one or multiple path loss reference reference signal parameters are included in the parameter to be applied to the transmit power control, at least one of a sounding reference signal resource set ID or a sounding reference signal resource ID is included in the parameter for the sounding reference signal, a first path loss reference reference signal is identified by using a sounding reference signal resource set ID, and a downlink path loss estimation is calculated by using the first path loss reference reference signal and the transmit power control is performed on the sounding reference signal by using the downlink path loss estimation.

(7) An integrated circuit according to an aspect of the present invention is an integrated circuit including: a transmitting unit configured to transmit, to a terminal apparatus, a higher layer configuration including a parameter for a sounding reference signal and a parameter to be applied to transmit power control; and a receiving unit configured to receive the sounding reference signal transmitted from the terminal apparatus, wherein one or multiple path loss reference reference signal parameters are included in the parameter to be applied to the transmit power control, at least one of a sounding reference signal resource set ID or a sounding reference signal resource ID is included in the parameter for the sounding reference signal, and the sounding reference signal is a signal obtained by calculating, by the terminal apparatus, a downlink path loss estimation by using a first path loss reference reference signal identified based on the sounding reference signal resource set ID and performing, by the terminal apparatus, the transmit power control by using the downlink path loss estimation.

### Advantageous Effects of Invention

According to an aspect of the present invention, a base station apparatus and a terminal apparatus can efficiently communicate with each other.

### BRIEF DESCRIPTION OF DRAWINGS

FIG. 1 is a diagram illustrating a concept of a radio communication system according to an embodiment of the present invention.

FIG. 2 is a diagram illustrating an example of an SS/PBCH block and an SS burst set according to an embodiment of the present invention.

FIG. 3 is a diagram illustrating a schematic configuration of an uplink slot and a downlink slot according to an embodiment of the present invention.

FIG. 4 is a diagram illustrating a relationship of a subframe, a slot, and a mini-slot in a time domain according to an embodiment of the present invention.

FIG. 5 is a diagram illustrating an example of a slot or a subframe according to an embodiment of the present invention.

FIG. 6 is a diagram illustrating an example of beamforming according to an embodiment of the present invention.

FIG. 7 is a diagram illustrating an example of SRS resources according to an embodiment of the present invention.

FIG. 8 is a diagram illustrating an example of SRS configurations according to an embodiment of the present invention.

FIG. 9 is a schematic block diagram illustrating a configuration of a terminal apparatus 1 according to an embodiment of the present invention.

FIG. 10 is a schematic block diagram illustrating a configuration of a base station apparatus 3 according to an embodiment of the present invention.

### DESCRIPTION OF EMBODIMENTS

Embodiments of the present invention will be described below.

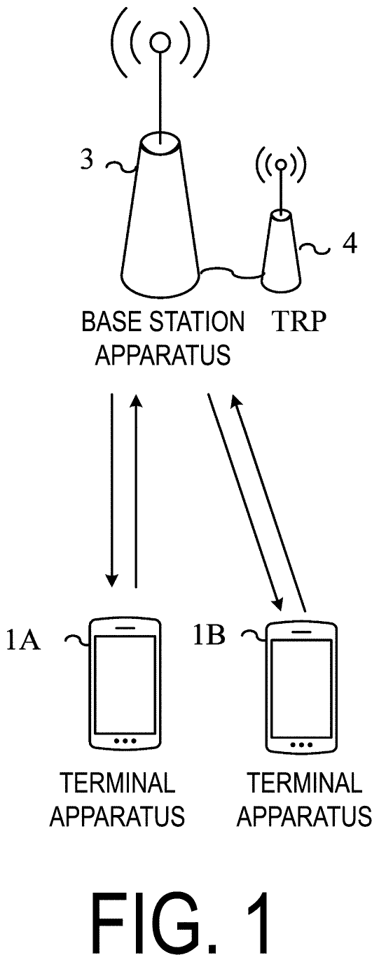

FIG. 1 is a conceptual diagram of a radio communication system according to the present embodiment. In FIG. 1, the radio communication system includes a terminal apparatus 1A, a terminal apparatus 1B, and a base station apparatus 3. The terminal apparatus 1A and the terminal apparatus 1B are also referred to as a terminal apparatus 1 below.

The terminal apparatus 1 is also called a user terminal, a mobile station device, a communication terminal, a mobile device, a terminal, User Equipment (UE), and a Mobile Station (MS). The base station apparatus 3 is also referred to as a radio base station apparatus, a base station, a radio base station, a fixed station, a NodeB (NB), an evolved NodeB (eNB), a Base Transceiver Station (BTS), a Base Station (BS), an NR NodeB (NR NB), NNB, a Transmission and Reception Point (TRP), or gNB. The base station apparatus 3 may include a core network apparatus. Furthermore, the base station apparatus 3 may include one or multiple transmission reception points (TRPs) 4. At least some of the functions/processing of the base station apparatus 3 described below may be the functions/processing of each of the transmission reception points 4 included in the base station apparatus 3. The base station apparatus 3 may use a communicable range (communication area) controlled by the base station apparatus 3, as one or multiple cells to serve the terminal apparatus 1. Furthermore, the base station apparatus 3 may use a communicable range (communication area) controlled by one or multiple transmission reception points 4, as one or multiple cells to serve the terminal apparatus 1. Furthermore, one cell may be divided into multiple beamed areas, and the terminal apparatus 1 may be served in each of the beamed areas. Here, a beamed area may be identified based on a beam index used for beamforming or a precoding index.

A radio communication link from the base station apparatus 3 to the terminal apparatus 1 is referred to as a downlink. A radio communication link from the terminal apparatus 1 to the base station apparatus 3 is referred to as an uplink.

In FIG. 1, in a radio communication between the terminal apparatus 1 and the base station apparatus 3, Orthogonal Frequency Division Multiplexing (OFDM) including a Cyclic Prefix (CP), Single-Carrier Frequency Division Multiplexing (SC-FDM), Discrete Fourier Transform Spread OFDM (DFT-S-OFDM), or Multi-Carrier Code Division Multiplexing (MC-CDM) may be used.

Furthermore, in FIG. 1, in the radio communication between the terminal apparatus 1 and the base station apparatus 3, Universal-Filtered Multi-Carrier (UFMC), Filtered OFDM (F-OFDM), Windowed OFDM, or Filter-Bank Multi-Carrier (FBMC) may be used.

Note that the present embodiment will be described in conjunction with OFDM symbols with the assumption that OFDM is used as a transmission scheme but that use of any other transmission scheme is also included in the present invention.

Furthermore, in FIG. 1, in the radio communication between the terminal apparatus 1 and the base station apparatus 3, the CP need not be used, or the above-described transmission scheme with zero padding may be used instead of the CP. Moreover, the CP or zero passing may be added both forward and backward.

An aspect of the present embodiment may be operated in carrier aggregation or dual connectivity with the Radio Access Technologies (RAT) such as LTE and LTE-A/LTE-A Pro. In this case, the aspect may be used for some or all of the cells or cell groups, or the carriers or carrier groups (e.g., Primary Cells (PCells), Secondary Cells (SCells), Primary Secondary Cells (PSCells), Master Cell Groups (MCGs), or Secondary Cell Groups (SCGs)). Moreover, the aspect may be independently operated and used in a stand-alone manner. In the dual connectivity operation, the Special Cell (SpCell) is referred to as a PCell of the MCG or a PSCell of the SCG, respectively, depending on whether a Medium Access Control (MAC) entity is associated with the MCG or the SCG. In a case that the operation is not in dual connectivity, the Special Cell (SpCell) is referred to as a PCell. The Special Cell (SpCell) supports PUCCH transmission and contention based random access.

In the present embodiment, one or multiple serving cells may be configured for the terminal apparatus 1. The multiple serving cells configured may include one primary cell and one or multiple secondary cells. The primary cell may be a serving cell on which an initial connection establishment procedure has been performed, a serving cell in which a connection re-establishment procedure has been initiated, or a cell indicated as a primary cell in a handover procedure. One or multiple secondary cells may be configured at a point of time in a case that or after a Radio Resource Control (RRC) connection is established. Note that the multiple serving cells configured may include one primary secondary cell. The primary secondary cell may be a secondary cell that is included in the one or multiple secondary cells configured and in which the terminal apparatus 1 can transmit control information in the uplink. Additionally, subsets of two types of serving cells corresponding to a master cell group and a secondary cell group may be configured for the terminal apparatus 1. The master cell group may include one primary cell and zero or more secondary cells. The secondary cell group may include one primary secondary cell and zero or more secondary cells.

Time Division Duplex (TDD) and/or Frequency Division Duplex (FDD) may be applied to the radio communication system according to the present embodiment. The Time Division Duplex (TDD) scheme or the Frequency Division Duplex (FDD) scheme may be applied to all of the multiple cells. Cells to which the TDD scheme is applied and cells to which the FDD scheme is applied may be aggregated.

A carrier corresponding to a serving cell in the downlink is referred to as a downlink component carrier (or a downlink carrier). A carrier corresponding to a serving cell in the uplink is referred to as an uplink component carrier (or an uplink carrier). A carrier corresponding to a serving cell in the sidelink is referred to as a sidelink component carrier (or a sidelink carrier). The downlink component carrier, the uplink component carrier, and/or the sidelink component carrier are collectively referred to as a component carrier (or a carrier).

Physical channels and physical signals according to the present embodiment will be described.

In FIG. 1, the following physical channels are used for the radio communication between the terminal apparatus 1 and the base station apparatus 3.
Physical Broadcast CHannel (PBCH)
Physical Downlink Control CHannel (PDCCH)
Physical Downlink Shared CHannel (PDSCH)
Physical Uplink Control CHannel (PUCCH)
Physical Uplink Shared CHannel (PUSCH)
Physical Random Access CHannel (PRACH)

The PBCH is used to broadcast essential information block ((Master Information Block (MIB), Essential Information Block (EIB), and Broadcast Channel (BCH)) which includes essential information needed by the terminal apparatus 1.

Additionally, the PBCH (also referred to as a physical broadcast channel) may be used to broadcast time indexes within the period of synchronization signal blocks (also referred to as SS/PBCH blocks). Here, the time index is information indicating the indexes of the synchronization signals and the PBCHs within the cell. For example, in a case that the SS/PBCH block is transmitted using the assumption of three transmit beams (transmission filter configuration and Quasi Co-Location (QCL) related to reception spatial parameters), the order of time within a prescribed period or within a configured period may be indicated. Additionally, the terminal apparatus may recognize the difference in time index as a difference in transmit beam. The synchronization signal blocks may include a primary synchronization signal, a secondary synchronization signal, a physical broadcast channel, and a reference signal for demodulating the physical broadcast channel. The primary synchronization signal, the secondary synchronization signal, and the reference signal for demodulating the physical broadcast channel will be described below.

The PDCCH is used to transmit (or carry) downlink control information (DCI) in a case of downlink radio communication (radio communication from the base station apparatus 3 to the terminal apparatus 1). Here, one or multiple pieces of DCI (which may be referred to as DCI formats) are defined for transmission of the downlink control information. In other words, a field for the downlink control information is defined as DCI and is mapped to information bits.

For example, the following DCI format may be defined.
DCI format 0_0
DCI format 0_1
DCI format 1_0
DCI format 1_1
DCI format 2_0
DCI format 2_1
DCI format 2_2
DCI format 2_3

DCI format 0_0 may include information indicating PUSCH scheduling information (frequency domain resource allocation and time domain resource allocation).

DCI format 0_1 may include information indicating PUSCH scheduling information (frequency domain resource allocation and time domain resource allocation), information indicating a BandWidth Part (BWP), a Channel State Information (CSI) request, a Sounding Reference Signal (SRS) request, and information related to antenna ports.

DCI format 1_0 may include information indicating PDSCH scheduling information (frequency domain resource allocation and time domain resource allocation).

DCI format 1_1 may include information indicating PDSCH scheduling information (frequency domain resource allocation and time domain resource allocation), information indicating a bandwidth part (BWP), Transmission Configuration Indication (TCI), and information related to the antenna ports.

DCI format 2_0 is used to notify the slot format of one or multiple slots. The slot format is defined as a format in which each OFDM symbol in the slot is classified as downlink, flexible, or uplink. For example, in a case that the slot format is 28, DDDDDDDDDDDDFU is applied to the 14 OFDM symbols in the slot for which slot format 28 is indicated. Here, D is a downlink symbol, F is a flexible symbol, and U is an uplink symbol. Note that the slot will be described below.

DCI format 2_1 is used to notify the terminal apparatus 1 of physical resource blocks and OFDM symbols which may be assumed to involve no transmission. Note that this information may be referred to as a pre-emption indication (intermittent transmission indication).

DCI format 2_2 is used for transmission of the PUSCH and a Transmit Power Control (TPC) command for the PUSCH.

DCI format 2_3 is used to transmit a group of TPC commands for transmission of sounding reference signals (SRSs) by one or multiple terminal apparatuses 1. Additionally, the SRS request may be transmitted along with the TPC command. In addition, the SRS request and the TPC command may be defined in the DCI format 2_3 for uplink with no PUSCH and PUCCH or uplink in which the transmit power control for the SRS is not associated with the transmit power control for the PUSCH.

Here, the DCI for the downlink is also referred to as downlink grant or downlink assignment. Here, the DCI for the uplink is also referred to as uplink grant or uplink assignment.

The PUCCH is used to transmit Uplink Control Information (UCI) in a case of uplink radio communication (radio communication from the terminal apparatus 1 to the base station apparatus 3). Here, the uplink control information may include Channel State Information (CSI) used to indicate a downlink channel state. The uplink control information may include Scheduling Request (SR) used to request an UL-SCH resource. The uplink control information may include a Hybrid Automatic Repeat request ACKnowledgement (HARQ-ACK). The HARQ-ACK may indicate an HARQ-ACK for downlink data (Transport block, Medium Access Control Protocol Data Unit (MAC PDU), or Downlink-Shared CHannel (DL-SCH)).

The PDSCH is used to transmit downlink data (Downlink Shared CHannel (DL-SCH)) from a Medium Access Control (MAC) layer. Furthermore, in a case of the downlink, the PSCH is used to transmit System Information (SI), a Random Access Response (RAR), and the like.

The PUSCH may be used to transmit uplink data (UpLink-Shared CHannel (UL-SCH)) from the MAC layer or to transmit the HARQ-ACK and/or CSI along with the uplink data. Furthermore, the PSCH may be used to transmit the CSI only or the HARQ-ACK and CSI only. In other words, the PSCH may be used to transmit the UCI only.

Here, the base station apparatus 3 and the terminal apparatus 1 exchange (transmit and/or receive) signals with each other in higher layers. For example, the base station apparatus 3 and the terminal apparatus 1 may transmit and/or receive Radio Resource Control (RRC) signaling (also referred to as a Radio Resource Control (RRC) message or Radio Resource Control (RRC) information) in an RRC layer. The base station apparatus 3 and the terminal apparatus 1 may transmit and/or receive a Medium Access Control (MAC) control element in a Medium Access Control (MAC) layer. Here, the RRC signaling and/or the MAC control element is also referred to as higher layer signaling. The higher layer as used herein means a higher layer as viewed from the physical layer, and thus may include one or multiple of the MAC layer, the RRC layer, an RLC layer, a PDCP layer, a Non Access Stratum (NAS) layer, and the like. For example, in the processing of the MAC layer, the higher layer may include one or multiple of the RRC layer, the RLC layer, the PDCP layer, the NAS layer, and the like.

The PDSCH or the PUSCH may be used to transmit the RRC signaling and the MAC control element. In this regard, in the PDSCH, the RRC signaling transmitted from the base station apparatus 3 may be signaling common to multiple terminal apparatuses 1 in a cell. The RRC signaling transmitted from the base station apparatus 3 may be dedicated signaling for a certain terminal apparatus 1 (also referred to as dedicated signaling). In other words, terminal apparatus-specific (UE-specific) information may be transmitted through dedicated signaling to the certain terminal apparatus 1. Additionally, the PUSCH may be used to transmit UE capabilities in the uplink.

In FIG. 1, the following downlink physical signals are used for downlink radio communication. Here, the downlink physical signals are not used to transmit information output from the higher layers but are used by the physical layer.
Synchronization signal (SS)
Reference Signal (RS)

The synchronization signal may include a Primary Synchronization Signal (PSS) and a Secondary Synchronization Signal (SSS). A cell ID may be detected by using the PSS and SSS.

The synchronization signal is used for the terminal apparatus 1 to establish synchronization in a frequency domain and a time domain in the downlink. Here, the synchronization signal may be used for the terminal apparatus 1 to select precoding or a beam in precoding or beamforming performed by the base station apparatus 3. Note that the beam may be referred to as a transmission or reception filter configuration, or a spatial domain transmission filter or a spatial domain reception filter.

A reference signal is used for the terminal apparatus 1 to perform channel compensation on a physical channel. Here, the reference signal is used for the terminal apparatus 1 to calculate the downlink CSI. Furthermore, the reference signal may be used for a numerology such as a radio parameter or subcarrier spacing, or used for fine synchronization that allows FFT window synchronization to be achieved.

According to the present embodiment, at least one of the following downlink reference signals are used.
Demodulation Reference Signal (DMRS)
Channel State Information Reference Signal (CSI-RS)
Phase Tracking Reference Signal (PTRS)
Tracking Reference Signal (TRS)

The DMRS is used to demodulate a modulated signal. Note that two types of reference signals may be defined as the DMRS: a reference signal for demodulating the PBCH and a reference signal for demodulating the PDSCH or that both reference signals may be referred to as the DMRS. The CSI-RS is used for measurement of Channel State Information (CSI) and beam management, and a transmission method for a periodic, semi-persistent, or aperiodic CSI reference signal is applied to the CSI-RS. For the CSI-RS, a Non-Zero Power (NZP) CSI-RS and a CSI-RS with zero transmit power (or receive power) (Zero Power (ZP)) may be defined. Here, the ZP CSI-RS may be defined as a CSI-RS resource that has zero transmit power or that is not transmitted. The PTRS is used to track phase on the time axis to ensure frequency offset caused by phase noise. The TRS is used to ensure Doppler shift during fast movement. Note that the TRS may be used as one configuration of the CSI-RS. For example, a radio resource may be configured with the CSI-RS for one port as a TRS.

According to the present embodiment, one or multiple of the following uplink reference signals are used.
Demodulation Reference Signal (DMRS)
Phase Tracking Reference Signal (PTRS)
Sounding Reference Signal (SRS)

The DMRS is used to demodulate a modulated signal. Note that two types of reference signals may be defined as the DMRS: a reference signal for demodulating the PUCCH and a reference signal for demodulating the PUSCH or that both reference signals may be referred to as the DMRS. The SRS is used for measurement of uplink channel state information (CSI), channel sounding, and beam management. The PTRS is used to track phase on the time axis to ensure frequency offset caused by phase noise.

The downlink physical channels and/or the downlink physical signals are collectively referred to as a downlink signal. The uplink physical channels and/or the uplink physical signals are collectively referred to as an uplink signal. The downlink physical channels and/or the uplink physical channels are collectively referred to as a physical channel. The downlink physical signals and/or the uplink physical signals are collectively referred to as a physical signal.

The BCH, the UL-SCH, and the DL-SCH are transport channels. A channel used in the Medium Access Control (MAC) layer is referred to as a transport channel A unit of the transport channel used in the MAC layer is also referred to as a Transport Block (TB) and/or a MAC Protocol Data Unit (PDU). A Hybrid Automatic Repeat reQuest (HARQ) is controlled for each transport block in the MAC layer. The transport block is a unit of data that the MAC layer delivers to the physical layer. In the physical layer, the transport block is mapped to a codeword, and coding processing is performed for each codeword.

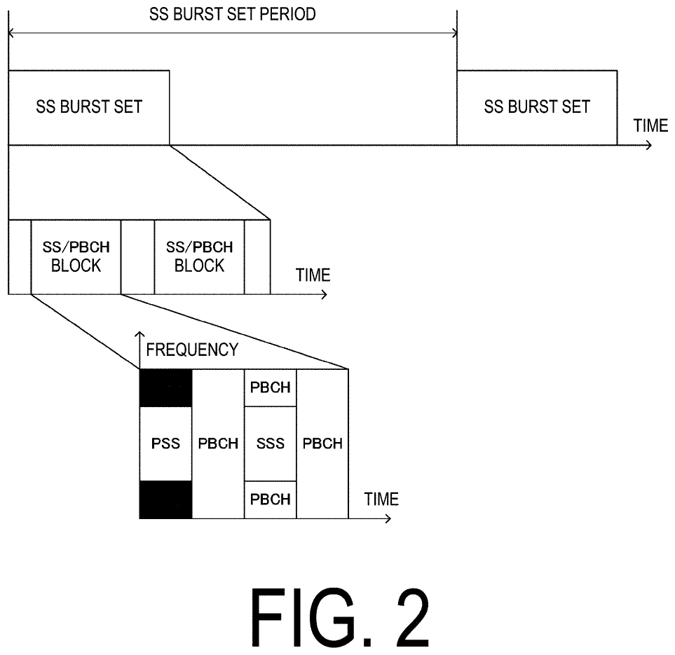

FIG. 2 is a diagram illustrating an example of SS/PBCH blocks (also referred to as synchronization signal blocks, SS blocks, and SSBs) and SS burst sets (also referred to as synchronization signal burst sets) according to the present embodiment. FIG. 2 illustrates an example in which two SS/PBCH blocks are included in a periodically transmitted SS burst set, and the SS/PBCH block includes four OFDM symbols.

The SS/PBCH block is a unit block including at least synchronization signals (PSS, SSS) and/or PBCHs. Transmitting the signals/channels included in the SS/PBCH block is described as transmitting the SS/PBCH block. In a case of transmitting the synchronization signals and/or the PBCHs using one or multiple SS/PBCH blocks in the SS burst set, the base station apparatus 3 may use an independent downlink transmission beam for each SS/PBCH block.

In FIG. 2, PSS, SSS, and PBCHs are time/frequency multiplexed in one SS/PBCH block. However, the order in which the PSS, the SSS, and/or the PBCHs are multiplexed in the time domain may be different from the order in the example illustrated in FIG. 2.

The SS burst set may be transmitted periodically. For example, a period used for initial access and a period configured for a connected (Connected or RRC_Connected) terminal apparatus may be defined. Furthermore, the period configured for the connected (Connected or RRC_Connected) terminal apparatus may be configured in the RRC layer. Additionally, the period configured for the connected (Connected or RRC_Connected) terminal may be a period of a radio resource in the time domain during which transmission is potentially to be performed, and in practice, whether the transmission is to be performed during the period may be determined by the base station apparatus 3. Furthermore, the period used for the initial access may be predefined in specifications or the like.

The SS burst set may be determined based on a System Frame Number (SFN). Additionally, a start position of the SS burst set (boundary) may be determined based on the SFN and the period.

The SS/PBCH block is assigned with an SSB index (which may be referred to as the SSB/PBCH block index) depending on the temporal position in the SS burst set. The terminal apparatus 1 calculates the SSB index, based on the information of the PBCH and/or the information of the reference signal included in the detected SS/PBCH block.

The SS/PBCH blocks with the same relative time in each SS burst set in the multiple SS burst sets are assigned with the same SSB index. The SS/PBCH blocks with the same relative time in each SS burst set in the multiple SS burst sets may be assumed to be QCLed (or the same downlink transmission beam may be assumed to be applied to these SS/PBCH blocks). In addition, antenna ports in the SS/PBCH blocks with the same relative time in each SS burst set in the multiple SS burst sets may be assumed to be QCLed for average delay, Doppler shift, and spatial correlation.

Within a certain SS burst set period, the SS/PBCH block assigned with the same SSB index may be assumed to be QCLed for average delay, average gain, Doppler spread, Doppler shift, and spatial correlation. A configuration corresponding to one or multiple SS/PBCH blocks (or the SS/PBCH blocks may be reference signals) that are QCLed may be referred to as a QCL configuration.

The number of SS/PBCH blocks (which may be referred to as the number of SS blocks or the SSB number) may be defined as, for example, the number of SS/PBCH blocks within an SS burst, an SS burst set, or an SS/PBCH block period. Additionally, the number of SS/PBCH blocks may indicate the number of beam groups for cell selection within the SS burst, the SS burst set, or the SS/PBCH block period. Here, the beam group may be defined as the number of different SS/PBCH blocks or the number of different beams included in the SS burst, the SS burst set, or the SS/PBCH block period.

Hereinafter, the reference signal described in the present embodiment includes a downlink reference signal, a synchronization signal, an SS/PBCH block, a downlink DMRS, a CSI-RS, an uplink reference signal, an SRS, and/or an uplink DMRS. For example, the downlink reference signal, the synchronization signal, and/or the SS/PBCH block may be referred to as a reference signal. The reference signals used in the downlink include a downlink reference signal, a synchronization signal, an SS/PBCH block, a downlink DMRS, a CSI-RS, and the like. The reference signals used in the uplink include an uplink reference signal, an SRS and/or an uplink DMRS, and the like.

The reference signal may also be used for Radio Resource Measurement (RRM). The reference signal may also be used for beam management.

Beam management may be a procedure of the base station apparatus 3 and/or the terminal apparatus 1 for matching directivity of an analog and/or digital beam in a transmission apparatus (the base station apparatus 3 in the downlink and the terminal apparatus 1 in the uplink) with directivity of an analog and/or digital beam in a reception apparatus (the terminal apparatus 1 in the downlink and the base station apparatus 3 in the uplink) to acquire a beam gain.

Note that the procedures described below may be included as a procedure for configuring, setting, or establishing a beam pair link.
Beam selection
Beam refinement
Beam recovery

For example, the beam selection may be a procedure for selecting a beam in communication between the base station apparatus 3 and the terminal apparatus 1. Furthermore, the beam refinement may be a procedure for selecting a beam having a higher gain or changing a beam to an optimum beam between the base station apparatus 3 and the terminal apparatus 1 according to the movement of the terminal apparatus 1. The beam recovery may be a procedure for re-selecting the beam in a case that the quality of a communication link is degraded due to blockage caused by a blocking object, a passing human being, or the like in communication between the base station apparatus 3 and the terminal apparatus 1.

Beam management may include beam selection and beam refinement. Note that the beam recovery may include the following procedures.
Detection of beam failure
Discovery of a new beam
Transmission of a beam recovery request
Monitoring of a response to the beam recovery request

For example, the Reference Signal Received Power (RSRP) of the SSS included in the CSI-RS or the SS/PBCH block may be used or a CSI may be used in selecting the transmission beam of the base station apparatus 3 at the terminal apparatus 1. Additionally, as a report to the base station apparatus 3, the CSI-RS Resource Index (CRI) may be used, or an index indicated in the PBCHs included in the SS/PBCH block and/or in a sequence of demodulation reference signals (DMRSs) used for demodulation of the PBCHs may be used.

Additionally, the base station apparatus 3 indicates the CRI or the time index of the SS/PBCH in indicating the beam to the terminal apparatus 1, and the terminal apparatus 1 receives the beam, based on the CRI or the time index of the SS/PBCH that is indicated. At this time, the terminal apparatus 1 may configure a spatial filter, based on the CRI or the time index of the SS/PBCH that is indicated, and receive the beam. Additionally, the terminal apparatus 1 may receive the beam by using the assumption of Quasi Co-Location (QCL). One signal (such as an antenna port, a synchronization signal, a reference signal, etc.) being “QCLed” with another signal (such as an antenna port, a synchronization signal, a reference signal, etc.) or “using the assumption of QCL” for these signals can be interpreted as the one signal being associated with the other signal.

In a case that a long term property of a channel on which one symbol in one antenna port is carried may be estimated from a channel on which one symbol in the other antenna port is carried, the two antenna ports are said to be quasi co-located. The long term property of the channel includes at least one of a delay spread, a Doppler spread, a Doppler shift, an average gain, or an average delay. For example, in a case that an antenna port 1 and an antenna port 2 are quasi co-located with respect to the average delay, this means that a reception timing for the antenna port 2 may be estimated from a reception timing for the antenna port 1.

The QCL may also be expanded to beam management. For this purpose, spatially expanded QCL may be newly defined. For example, the long term property of a channel in spatial QCL assumption may be an Angle of Arrival (AoA), a Zenith angle of Arrival (ZoA), or the like and/or an angle spread, for example, Angle Spread of Arrival (ASA) or a Zenith angle Spread of Arrival (ZSA), a transmission angle (AoD, ZoD, or the like) or an angle spread of the transmission angle, for example, an Angle Spread of Departure (ASD) or a Zenith angle Spread of Departure (ZSD), or Spatial Correlation, or a reception spatial parameter in a radio link or channel.

For example, in a case that the antenna port 1 and the antenna port 2 may be considered to be QCLed with respect to a reception spatial parameter, this means that a reception beam (reception spatial filter) in which a signal from the antenna port 2 is received may be inferred from a reception beam in which a signal from the antenna port 1 is received.

As QCL types, combinations of long term properties that may be considered to be QCLed may be defined. For example, the following types may be defined.
Type A: Doppler shift, Doppler spread, average delay, delay spread
Type B: Doppler shift, Doppler spread
Type C: Average delay, Doppler shift
Type D: Reception spatial parameter

The above-described QCL types may configure and/or indicate the assumption of QCL of the one or two reference signals and the PDCCH or the PDSCH DMRS in the RRC and/or MAC layer and/or DCI as a Transmission Configuration Indication (TCI). For example, in a case that the index #2 of the SS/PBCH block and the QCL type A+QCL type D are configured and/or indicated as one state of the TCI in a case that the terminal apparatus 1 receives the PDCCH, then at the time of reception of the PDCCH DMRS, the terminal apparatus 1 may receive the PDCCH DMRS and perform synchronization and channel estimation, with the Doppler shift, Doppler spread, average delay, delay spread, and reception spatial parameter in the reception of SS/PBCH block index #2 considered as the long term properties of the channels. At this time, the reference signal (in the example described above, the SS/PBCH block) indicated by the TCI may be referred to as a source reference signal, and the reference signal (in the above-described example, the PDCCH DMRS) affected by the long term property inferred from the long term property of the channel in a case that the source reference signal is received may be referred to as a target reference signal. Additionally, for the TCI, the RRC configures multiple TCI states and a combination of the source reference signal and the QCL type for each state, and the TCI may be indicated to the terminal apparatus 1 by using the MAC layer or DCI.

According to this method, operations of the base station apparatus 3 and the terminal apparatus 1 equivalent to beam management may be defined based on the QCL assumption for the spatial domain and radio resources (time and/or frequency) as beam management and beam indication/report.

The subframe will now be described. The subframe in the present embodiment may also be referred to as a resource unit, a radio frame, a time period, or a time interval.

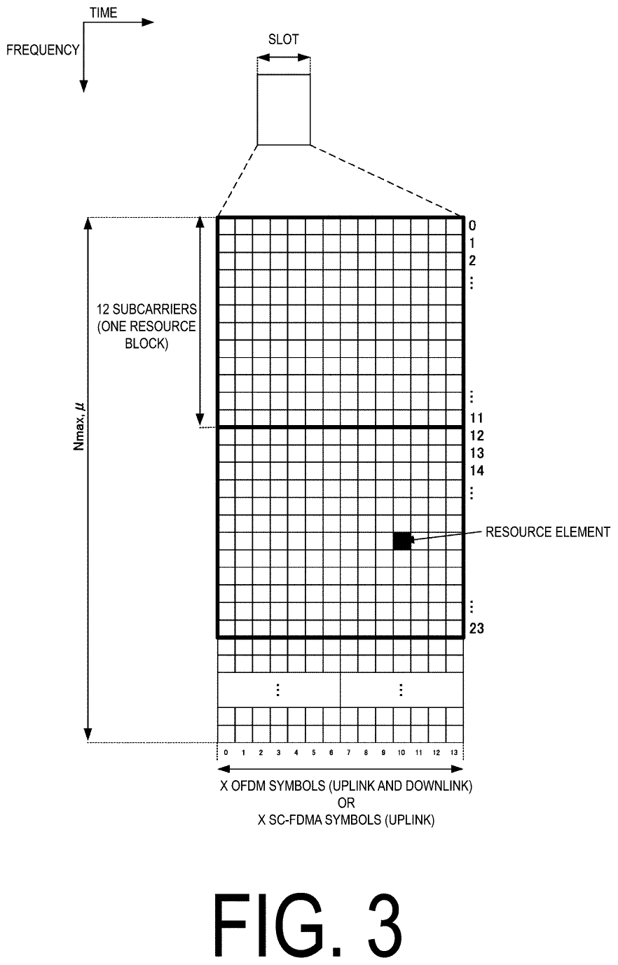

FIG. 3 is a diagram illustrating a general configuration of an uplink and a downlink slots according to a first embodiment of the present invention. Each of the radio frames is 10 ms in length. Additionally, each of the radio frames includes 10 subframes and W slots. In addition, one slot includes X OFDM symbols. In other words, the length of one subframe is 1 ms. For each of the slots, time length is defined based on subcarrier spacings. For example, in a case that the subcarrier spacing of an OFDM symbol is 15 kHz and Normal Cyclic Prefixes (NCPs) are used, X=7 or X=14, and X=7 ad X=14 correspond to 0.5 ms and 1 ms, respectively. In addition, in a case that the subcarrier spacing is 60 kHz, X=7 or X=14, and X=7 and X=14 correspond to 0.125 ms and 0.25 ms, respectively. Additionally, for example, for X=14, W=10 in a case that the subcarrier spacing is 15 kHz, and W=40 in a case that the subcarrier spacing is 60 kHz. FIG. 3 illustrates a case of X=7 as an example. Note that a case of X=14 can be similarly configured by expanding the case of X=7. Furthermore, the uplink slot is defined similarly, and the downlink slot and the uplink slot may be defined separately. Additionally, the bandwidth of the cell of FIG. 3 may also be defined as a part of the band (BandWidth Part (BWP)). In addition, the slot may be referred to as a Transmission Time Interval (TTI). The slot need not be defined as a TTI. The TTI may be a transmission period for transport blocks.

The signal or the physical channel transmitted in each of the slots may be represented by a resource grid. The resource grid is defined by multiple subcarriers and multiple OFDM symbols. The number of subcarriers constituting one slot depends on each of the downlink and uplink bandwidths of a cell. Each element in the resource grid is referred to as a resource element. The resource element may be identified by using a subcarrier number and an OFDM symbol number.

The resource grid is used to represent mapping of a certain physical downlink channel (such as the PDSCH) or a certain physical uplink channel (such as the PUSCH) to resource elements. For example, for a subcarrier spacing of 15 kHz, in a case that the number X of OFDM symbols included in a subframe is 14 and NCPs are used, one physical resource block is defined by 14 continuous OFDM symbols in the time domain and by 12*Nmax continuous subcarriers in the frequency domain. Nmax is the maximum number of resource blocks determined by a subcarrier spacing configuration μ described below. In other words, the resource grid includes (14*12*Nmax, μ) resource elements. Extended CPs (ECPs) are supported only at a subcarrier spacing of 60 kHz, and one physical resource block is defined by 12 (the number of OFDM symbols included in one slot)*4 (the number of slots included in one subframe) in the time domain=48 continuous OFDM symbols, 12*Nmax, μ continuous subcarriers in the frequency domain, for example. In other words, the resource grid includes (48*12*Nmax, μ) resource elements.

As resource blocks, a common resource block, a physical resource block, and a virtual resource block are defined. One resource block is defined as 12 subcarriers that are continuous in the frequency domain. Subcarrier index 0 at common resource block index 0 may be referred to as a reference point (which may be referred to as point A). The common resource blocks are resource blocks numbered in ascending order from 0 at each subcarrier spacing configuration μ starting at the reference point A. The resource grid described above is defined by the common resource blocks. The physical resource blocks are resource blocks numbered in ascending order from 0 included in a bandwidth part (BWP) described below, and the physical resource blocks are resource blocks numbered in ascending order from 0 included in the bandwidth part (BWP). A certain physical uplink channel is first mapped to a virtual resource block. Thereafter, the virtual resource block is mapped to a physical resource block.

Now, the subcarrier spacing configuration μ will be described. As described above, multiple OFDM numerologies are supported in NR. In a certain BWP, the subcarrier spacing configuration μ μ=0, 1, . . . 5) and the cyclic prefix length are given for a downlink BWP by the higher layer and for an uplink BWP by the higher layer. In this regard, given μ, a subcarrier spacing Δf is given by Δf=2\hat{ }μ*15 (kHz).

At the subcarrier spacing configuration μ, the slots are counted in ascending order from 0 to N\hat{ }{subframe, μ}_{slot}−1 within the subframe, and counted in ascending order from 0 to N\hat{ }{frame, μ}_{slot}−1 within the frame. N\hat{ }{slot}_{symb} continuous OFDM symbols are in the slot, based on the slot configuration and the cyclic prefix. N\hat{ }{slot}_{symb} is 14. The start of the slot n\hat{ }{μ}_{s} within the subframe is temporally aligned with the start of the n\hat{ }{μ}_{s} N\hat{ }{slot}_{symb}th OFDM symbol within the same subframe.

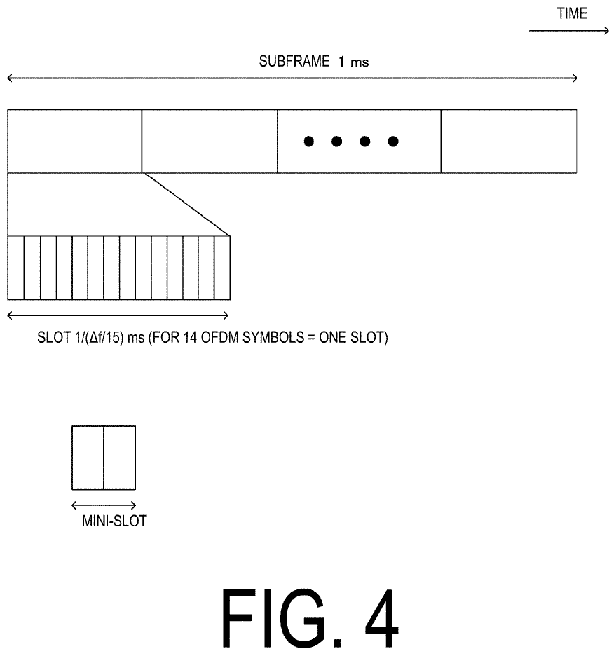

The subframe, the slot, and a mini-slot will now be described. FIG. 4 is a diagram illustrating the relationship of a subframe, slots, and mini-slots in the time domain. As illustrated in FIG. 4, three types of time units are defined. The subframe is 1 ms regardless of the subcarrier spacing. The number of OFDM symbols included in the slot is 7 or 14, and the slot length depends on the subcarrier spacing. Here, in a case that the subcarrier spacing is 15 kHz, 14 OFDM symbols are included in one subframe. The downlink slot may be referred to as PDSCH mapping type A. The uplink slot may be referred to as PUSCH mapping type A.

The mini-slot (which may be referred to as a sub-slot) is a time unit including OFDM symbols that are less in number than the OFDM symbols included in the slot. FIG. 4 illustrates, by way of example, a case in which the mini-slot includes 2 OFDM symbols. The OFDM symbols in the mini-slot may match the timing for the OFDM symbols constituting the slot. Note that the smallest unit of scheduling may be a slot or a mini-slot. Additionally, allocation of mini-slots may be referred to as non-slot based scheduling. Mini-slots being scheduled may also be expressed as resources being scheduled for which the relative time positions of the start positions of the reference signal and the data are fixed. The downlink mini-slot may be referred to as PDSCH mapping type B. The uplink mini-slot may be referred to as PUSCH mapping type B.

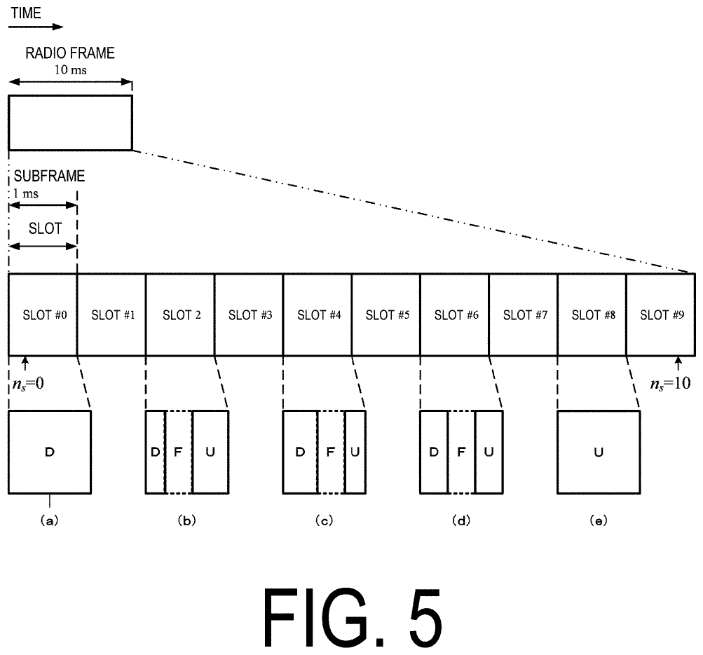

FIG. 5 is a diagram illustrating an example of a slot format. In this regard, a case in which the slot length is 1 ms at a subcarrier spacing of 15 kHz is illustrated as an example. In FIG. 5, D represents the downlink, and U represents the uplink. As illustrated in FIG. 5, during a certain time interval (for example, the minimum time interval to be allocated to one UE in the system), at least one or multiple of the following types of symbols may be included:
downlink symbols,
flexible symbols, and
uplink symbols. Note that the ratio of these symbols may be preset as a slot format.
   Additionally, the definition may be made based on the number of downlink OFDM symbols included in the slot, and the start position and end position of the symbols within the slot. Additionally, the number of uplink OFDM symbols or DFT-S-OFDM symbols included in the slot or the start position and end position of the symbols within the slot may be defined. Note that the slot being scheduled may be expressed as resources being scheduled for which the relative time positions of the reference signal and the slot boundary are fixed.

The terminal apparatus 1 may receive a downlink signal or a downlink channel in the downlink symbols or the flexible symbols. The terminal apparatus 1 may transmit an uplink signal or a downlink channel in the uplink symbols or the flexible symbols.

FIG. 5(a) illustrates an example of a certain time interval (which may be referred to as, for example, a minimum unit of time resource that can be allocated to one UE, a time unit, or the like, additionally, a set of multiple minimum units of time resources may be referred to as a time unit) in which all of the slot is used for downlink transmission, and in FIG. 5(b), the slot is used such that in the first time resource, for example, the uplink is scheduled via the PDCCH and that after a flexible symbol including a processing delay of the PDCCH, a time for switching from downlink to uplink, and generation of a transmission signal, an uplink signal is transmitted. In FIG. 5(c), the slot is used such that in the first time resource, the PDCCH and/or the downlink PDSCH is transmitted and that after a gap for a processing delay, a time for switching from downlink to uplink, and generation of a transmission signal, the PUSCH or PUCCH is transmitted. Here, for example, the uplink signal may be used to transmit the HARQ-ACK and/or CSI, namely, the UCI. In FIG. 5(d), the slot is used such that in the first time resource, the PDCCH and/or the PDSCH is transmitted and that after a gap for a processing delay, a time for switching from downlink to uplink, and generation of a transmit signal, the uplink PUSCH and/or PUCCH is transmitted. Here, for example, the uplink signal may be used to transmit the uplink data, namely, the UL-SCH. In FIG. 5(e), the entire slot is used for uplink transmission (PUSCH or PUCCH).

The above-described downlink part and uplink part may include multiple OFDM symbols as is the case with LTE.

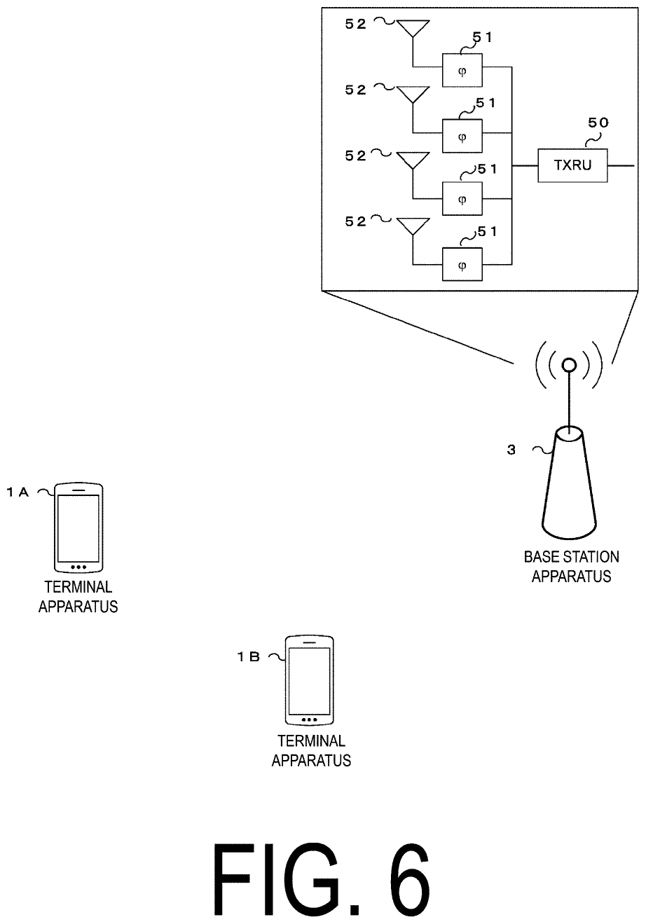

FIG. 6 is a diagram illustrating an example of beamforming. Multiple antenna elements are connected to one Transceiver unit (TXRU) 50. The phase is controlled by using a phase shifter 51 for each antenna element and a transmission is performed from an antenna element 52, thus allowing a beam for a transmit signal to be directed in any direction. Typically, the TXRU may be defined as an antenna port. Controlling the phase shifter 51 allows configuration of directivity in any direction. Thus, the base station apparatus 3 can communicate with the terminal apparatus 1 by using a high gain beam, and the terminal apparatus 1 can communicate with the base station apparatus 3 by using a high gain beam. The terminal apparatus 1 and/or the base station apparatus 3 can include multiple transmission units. Furthermore, a large number of the terminal apparatuses 1 and/or the base station apparatuses 3 can divide the transmission units into multiple panels, and apply different transmission and/or reception beams for the respective panels at the same timing. Additionally, in a case that the terminal apparatus 1 includes multiple panels, the above-described beam management may be a panel-by-panel procedure. In other words, the base station apparatus 3 may configure, for the terminal apparatus 1, the association between the reference signal and the panel.

Hereinafter, the bandwidth part (BWP) will be described. The BWP is also referred to as a carrier BWP. The BWP may be configured for each of the downlink and the uplink. The BWP is defined as a set of continuous physical resources selected from continuous subsets of common resource blocks. The terminal apparatus 1 can be configured with up to four BWPs such that one downlink carrier BWP is activated at a certain time. The terminal apparatus 1 can be configured with up to four BWPs such that one uplink carrier BWP is activated at a certain time. In a case of carrier aggregation, the BWP may be configured in each serving cell. At this time, one BWP being configured in a certain serving cell may be expressed as no BWP being configured. Two or more BWPs being configured may also be expressed as the BWP being configured.

### MAC Entity Operation

An activated serving cell always includes one active (activated) BWP. BWP switching for a certain serving cell is used to activate an inactive (deactivated) BWP and to deactivate an active (activated) BWP. BWP switching for a certain serving cell is controlled by the PDCCH indicating downlink allocation or uplink grant. BWP switching for a certain serving cell may be further controlled by a BWP inactivity timer, or by the MAC entity itself at the initiation of a random access procedure. In the addition of the SpCell (PCell or PSCell) or the activation of the SCell, one of the BWPs is an initially active BWP without reception of the PDCCH indicating downlink allocation or uplink grant. The initially active BWP may be designated in an RRC message sent from the base station apparatus 3 to the terminal apparatus 1. The active BWP for a certain serving cell is designated in the RRC or PDCCH sent from the base station apparatus 3 to the terminal apparatus 1. In an unpaired spectrum (TDD bands or the like), the DL BWP and the UL BWP are paired, and the BWP switching is common to the UL and DL. In the active BWP for each of the activated serving cells for which the BWP is configured, the MAC entity of the terminal apparatus 1 applies normal processing. The normal processing includes transmitting a UL-SCH, transmitting an RACH, monitoring the PDCCH, transmitting the PUCCH, transmitting the SRS, and receiving the DL-SCH. In the inactive BWP for each of the activated serving cells for which the BWP is configured, the MAC entity of the terminal apparatus 1 does not transmit the UL-SCH, does not transmit the RACH, does not monitor the PDCCH, does not transmit the PUCCH, does not transmit the SRS, and does not receive the DL-SCH. In a case that a certain serving cell is deactivated, the active BWP may be configured to be absent (e.g., the active BWP is deactivated).

### RRC Operation

BWP information elements (IEs) included in the RRC message (broadcast system information or information sent in a dedicated RRC message) is used to configure the BWP. The RRC message transmitted from the base station apparatus 3 is received by the terminal apparatus 1. For each serving cell, a network (such as the base station apparatus 3) configures, for the terminal apparatus 1, at least an initial BWP including at least a downlink BWP and one uplink BWP (such as a case that the serving cell is configured with the uplink) or two uplink BWPs (such as a case that a supplementary uplink is used). Furthermore, the network may configure an additional uplink BWP or downlink BWP for a certain serving cell. The BWP configuration is divided into uplink parameters and downlink parameters. Additionally, the BWP configuration is also divided into common parameters and dedicated parameters. The common parameters (such as a BWP uplink common IE and a BWP downlink common IE) are cell specific. The common parameters for the initial BWP of the primary cell are also provided by using system information. For all the other serving cells, the network provides the common parameters through dedicated signals. The BWP is identified by a BWP ID. For the initial BWP, the BWP ID is 0. For each of the other BWPs, the BWP ID takes a value ranging from 1 to 4.

The dedicated parameters for the uplink BWP include SRS configurations. The uplink BWP corresponding to the dedicated parameters for the uplink BWP are associated with one or multiple SRSs corresponding to the SRS configurations included in the dedicated parameters for the uplink BWP.

The time and frequency resources for SRS transmission which are used by the terminal apparatus 1 are controlled by the base station apparatus 3. More specifically, the configurations imparted by the higher layer for the above-described BWP includes configurations related to the SRS. The configurations related to the SRS include a configuration of SRS resources, a configuration related to SRS resource sets, and a configuration of a trigger state. Each of the configurations will be described.

A case in which one or multiple SRS resources are configured will be described. The base station apparatus 3 configures multiple SRS resources for the terminal apparatus 1. The multiple SRS resources are associated with last several symbols of the uplink slot. For example, it is assumed that four SRS resources are configured, and each SRS resource is associated with a corresponding one of last four symbols of the slot. The terminal apparatus 1 performs transmission in SRS symbols by using a transmission beam (transmission filter).

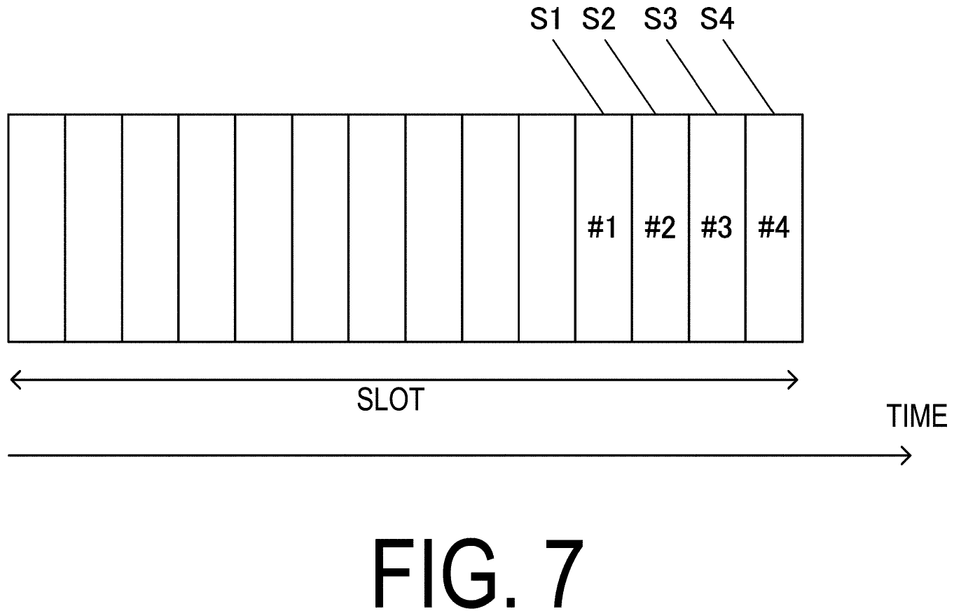

FIG. 7 illustrates an example of SRS symbols in a case that four SRS resources are configured. S1 is an SRS resource associated with SRS resource #1, S2 is an SRS resource associated with SRS resource #2, S3 is an SRS resource associated with SRS resource #3, and S4 is an SRS resource associated with SRS resource #4. Based on this configuration, the terminal apparatus 1 transmits the SRS by applying different transmission beams to the respective resources.

The terminal apparatus 1 may use different transmission antenna ports for the respective SRS resources. For example, the SRS may be transmitted by using an antenna port 10 for S1, an antenna port 11 for S2, an antenna port 12 for S3, and an antenna port 13 for S4.

The terminal apparatus 1 may perform transmission by using multiple transmission antenna ports or transmission antenna port groups for each SRS resource. For example, transmission may be performed by using the antenna ports 10 and 11 for S1, and the antenna ports 12 and 13 for S2.

The configuration of SRS resources includes spatial relation information (Spatial Relation Info). The spatial relation information is information for applying a separately applied reception or transmission filter configuration to a transmission filter for a sounding reference signal and acquiring a beam gain. For determination of the separately applied reception or transmission filter configuration, any of the synchronization signal block, the CSI reference signal, and the sounding reference signal is configured as a signal to be received or transmitted.

In addition to the spatial relation information, the SRS resource configuration may include at least one or multiple of the information elements described below.

(1) Information or index related to symbols for transmitting the sounding reference signal

(2) Information related to the antenna port through which the sounding reference signal is transmitted

(3) Frequency hopping pattern for the sounding reference signal

The terminal apparatus 1 may configure an SRS resource set including one or multiple SRS resource configurations.

The SRS resource set configuration may include information related to transmit power control applied to SRS resources included in the set.

The SRS resource configuration and/or SRS resource set configuration may include information for configuring operation in the time domain. As the information for configuring the operation in the time domain, one of “periodic”, “semi-persistent”, and “aperiodic” is configured.

The terminal apparatus 1 may be configured with panel ID information including one or multiple SRS resource configurations.

The configuration relating to the panel ID information may include information related to transmit power control applied to the SRS resources included in the set.

The base station apparatus 3 may select one or multiple of the SRS resources configured, and indicate an index SRI (SRS Resource Index) associated with the SRS resource or an index associated with the SRI for PUSCH transmission, to the terminal apparatus 1 by DCI or MAC CE or RRC signaling. The terminal apparatus 1 may receive, among the SRS resources configured, the SRI, the index associated with the SRS resource, or the index associated with the SRI from the base station apparatus 3 by DCI or MAC CE or RRC signaling. The terminal apparatus 1 performs PUSCH transmission by using one or multiple antenna ports for DMRSs associated with specified SRS resources and/or one or multiple antenna ports for the PUSCH. For example, in a case that the terminal apparatus 1 transmits the SRS by using transmit beams #1 to #4 in four SRS resources, and SRS resource #2 is indicated as an SRI by the base station apparatus 3, the terminal apparatus 1 may transmit the PUSCH by using transmit beam #2. Additionally, in a case that multiple SRS resources are indicated, multiple transmission beams used on the SRS resource associated with the indicated SRI may be used to transmit the PUSCH by MIMO spatial multiplexing (Multiple Input Multiple Output Spatial Multiplexing (MIMO SM)).

The base station apparatus 3 may select one or multiple of the SRS resources configured, and indicate the index SRI associated with the SRS resource or the index associated with the SRI for PUCCH transmission, to the terminal apparatus 1 by DCI or a MAC CE or RRC signaling. Information for determining the SRS resource associated with the PUCCH is included in the DCI for downlink resource allocation. The terminal apparatus 1 decodes the PDSCH, based on the DCI for downlink resource allocation, and transmits the HARQ-ACK on the PUCCH resource indicated in the DCI for downlink resource allocation. The terminal apparatus 1 may receive, among the SRS resources configured, the SRI, the index associated with the SRS resource, or the index associated with the SRI from the base station apparatus 3 by DCI or MAC CE or RRC signaling. The terminal apparatus 1 performs PUCCH transmission by using one or multiple antenna ports for DMRSs associated with specified SRS resources and/or one or multiple antenna ports for the PUCCH.

The base station apparatus 3 may associate periodicity and offset information with SRS resources for which periodic operation is configured for the time domain among the SRS resources, and indicate the association to the terminal apparatus 1 by DCI or MAC CE or RRC signaling. The terminal apparatus 1 periodically performs SRS transmission by using transmission periodicity and offset information associated with SRS resources for which periodic operation is configured for the time domain among the SRS resources.

The base station apparatus 3 may associate the periodicity and offset information with SRS resources for which semi-persistent operation is configured for the time domain among the SRS resources, and indicate the association to the terminal apparatus 1 by DCI or MAC CE or RRC signaling. For SRS resources for which semi-persistent operation is configured for the time domain among the SRS resources, the base station apparatus 3 may indicate activation/deactivation of the SRS resource to the terminal apparatus 1 by DCI or MAC CE or RRC signaling. For SRS resources for which semi-persistent operation is configured for the time domain among the SRS resources, the terminal apparatus 1 may receive the activation/deactivation of the SRS resource from the base station apparatus 3 by DCI or MAC CE or RRC signaling. In a case of receiving an activation indication, the terminal apparatus 1 performs periodic SRS transmission by using information or indexes related to symbols on which the SRS is transmitted, and/or information related to the antenna port through which the SRS is transmitted, and/or the frequency hopping pattern information regarding the SRS, all of the information being associated with the specified SRS resource, and using the periodicity and offset information associated with the specified SRS resource. In a case of receiving the deactivation indication, the terminal apparatus 1 stops SRS transmission of the specified SRS resource.

For SRS resources for which aperiodic operation is configured for the time domain among the SRS resources, the base station apparatus 3 may indicate an SRS transmission request (SRS request) to the terminal apparatus 1 by DCI or MAC CE or RRC signaling. For SRS resources for which aperiodic operation is configured for the time domain among the SRS resources, the terminal apparatus 1 may receive the SRS transmission request (SRS request) from the base station apparatus 3 by DCI or MAC CE or RRC signaling. In a case of receiving the SRS transmission request (SRS request), the terminal apparatus 1 performs SRS transmission by using the information or indexes related to the symbols on which the SRS is transmitted, and/or the information related to the antenna port through which the SRS is transmitted, and/or the frequency hopping pattern information regarding the SRS, all of the information being associated with the specified SRS resource, and using the periodicity and offset information associated with the specified SRS resource. The SRS transmission request (SRS request) includes one or multiple trigger states, and those, of the SRS resource configurations and/or the SRS resource set configurations, for which aperiodic operation is configured for the time domain are associated with one or multiple trigger states.

Now, the configuration of the trigger state will be described. Each trigger state is associated with a configuration related to one or multiple SRS resource sets.

For SRS resource sets for aperiodic operation in the time domain, higher layer configurations include uplink channel state information (CSI) on one or multiple component carriers, and/or the trigger state for SRS transmission on one or multiple SRS resource sets for channel sounding and/or beam management. For triggering of SRS transmission in the aperiodic SRS resource set, a set of one SRS trigger state is configured by a higher layer parameter. Each trigger state is indicated by using an SRS request field included in the DCI (e.g., DCI format 0_1, DCI format 1_1, and DCI format 2_3).

In this case, the terminal apparatus performs the following operations.
In a case that the SRS request field has a value of 0, SRS transmission is not requested
In a case that the value of the SRS request field is 1 or 2 or 3, SRS transmission is performed based on the configuration related to the SRS resource set associated with the corresponding trigger state. At this time, the terminal apparatus transmits the SRS, based on configuration information included in the configuration related to the SRS resource from the SRS resource set.

The configuration related to each SRS resource set includes information for configuring the operation in the time domain, and the index or identity of a signal related to spatial relation information.

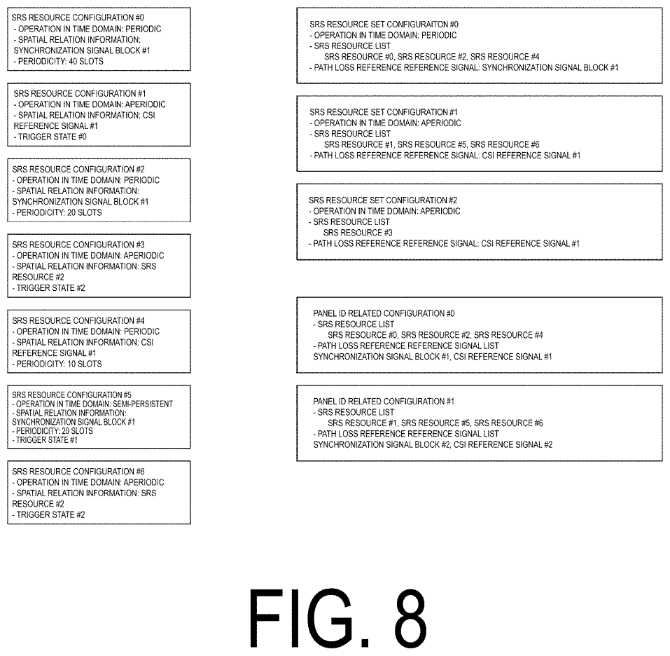

FIG. 8 illustrates an example of RRC configurations related to the SRS in certain serving cell #1. As illustrated in FIG. 8, seven configurations for SRS resources are provided. Of the configurations, configurations #0, #2, and #4 are for periodic SRS resource configurations, configurations #1, #2, and #6 are for aperiodic SRS resource configurations, and configuration #5 is for a semi-persistent SRS resource configuration.

Configurations for aperiodic and semi-persistent SRS resources include trigger state information, and in the example of FIG. 8, configuration #1 is associated with trigger state #0, configuration #3 is associated with trigger state #2, configuration #5 is associated with trigger state #1, and configuration #6 is associated with trigger state #2.

The terminal apparatus 1 transmits the SRS, based on the configuration related to the SRS configured by the RRC and the configuration related to the SRS resource set associated based on the value of the SRS request field included in the DCI. At this time, the terminal apparatus 1 transmits, from the SRS resource set associated with the configuration related to the SRS, the SRS, based on configuration information included in the configuration related to the SRS. As an example, the SRS request field may include two bits, and may be associated with a value expressing, in two bits, a trigger state associated with the above-described SRS resource and/or SRS resource set.

In this regard, in the example described above, a configuration related to one SRS resource set is configured for one value of the SRS request field, but multiple SRS resource sets may be associated.

FIG. 8 also illustrates an example of configurations of the SRS resource sets configured by the RRC in certain two serving cells, and the configurations of information related to the panel ID.

For the terminal apparatus 1, one primary cell and up to 15 secondary cells may be configured.

Hereinafter, a Random Access Procedure will be described. The random access procedure is classified into two procedures including a Contention Based (CB) procedure and a non-CB (which may be referred to as Contention Free (CF)) procedure. The contention based random access is also referred to as CBRA, and the non-contention based random access is also referred to as CFRA. The random access procedure is initiated by a PDCCH order, a MAC entity, a beam failure notification from a lower layer, RRC, or the like.

The contention based random access procedure is initiated by a PDCCH order, a MAC entity, a beam failure notification from a lower layer, RRC, or the like. In a case that the beam failure notification is provided to the MAC entity of the terminal apparatus 1 by the physical layer of the terminal apparatus 1 and that a certain condition is satisfied, the MAC entity of the terminal apparatus 1 initiates the random access procedure. A beam failure recovery procedure may refer to a procedure for determining whether a certain condition is satisfied and initiating a random access procedure, in a case that the beam failure notification is provided to the MAC entity of the terminal apparatus 1 by the physical layer of the terminal apparatus 1. This random access procedure is a random access procedure for a beam failure recovery request. The random access procedure initiated by the MAC entity includes a random access procedure initiated by a scheduling request procedure. The random access procedure for the beam failure recovery request may or may not be considered as a random access procedure initiated by the MAC entity. Different procedures may be used for the random access procedure for the beam failure recovery request and the random access procedure initiated by the scheduling request procedure, and thus the random access procedure for the beam failure recovery request and the scheduling request procedure may be distinguished from each other. The random access procedure for the beam failure recovery request and the scheduling request procedure may be random access procedures initiated by the MAC entity. In an embodiment, the random access procedure initiated by the scheduling request procedure may be referred to as the random access procedure initiated by the MAC entity, and the random access procedure for the beam failure recovery request may be referred to as a random access procedure based on a beam failure notification from a lower layer. Hereinafter, the initiation of the random access procedure in a case of receiving the beam failure notification from the lower layer may mean the initiation of the random access procedure for the beam failure recovery request.

The terminal apparatus 1 performs the contention based random access procedure at the time of initial access in a state where the terminal apparatus 1 is not connected (in communication) with the base station apparatus 3, and/or during a scheduling request in a case that the terminal apparatus 1 is connected with the base station apparatus 3 and where uplink data that can be transmitted to the terminal apparatus 1 or transmittable sidelink data is generated. However, the contention based random access is not limited to the above-described applications. The generation of the uplink data that can be transmitted to the terminal apparatus 1 may include triggering of a buffer status report corresponding to the transmittable uplink data. The generation of the uplink data that can be transmitted to the terminal apparatus 1 may include pending of the scheduling request triggered based on the generation of transmittable uplink data. The generation of sidelink data that can be transmitted to the terminal apparatus 1 may include triggering of a buffer status report corresponding to the transmittable sidelink data. The generation of the sidelink data that can be transmitted to the terminal apparatus 1 may include pending of the scheduling request triggered based on the generation of the sidelink data that can be transmitted.

The non-contention based random access procedure may be initiated in a case that the terminal apparatus 1 receives, from the base station apparatus 3, information indicating the initiation of the random access procedure. The non-contention based random access procedure may be initiated in a case that the MAC layer of the terminal apparatus 1 receives the beam failure notification from the lower layer. The non-contention based random access may be used to quickly perform uplink synchronization between the terminal apparatus 1 and the base station apparatus 3 in a case that the base station apparatus 3 and the terminal apparatus 1 are connected but handover or a transmission timing for a mobile station device is not valid. The non-contention based random access may be used to transmit a beam failure recovery request in a case that beam failure occurs in the terminal apparatus 1. Note that, the non-contention based random access is not limited to the above-described applications. Note that, information indicating the initiation of the random access procedure may be referred to as message 0, Msg.0, NR-PDCCH order, PDCCH order, etc. Note that, in a case that the random access preamble index indicated by message 0 is a prescribed value (for example, in a case that all of the bits indicating the index are 0), the terminal apparatus 1 may perform a contention based random access procedure for randomly selecting and transmitting one preamble from the set of preambles available to the terminal apparatus 1.

The terminal apparatus 1 receives the random access configuration information via the higher layer before initiating the random access procedure. The random access configuration information may include resources available for preamble transmission or various parameters for preamble transmission (the number of transmissions and power configuration), information regarding associated SS/PBCH blocks, or information for determining/configuring those pieces of information. However, the random access configuration information may include common information within the cell, and dedicated information varying among the terminals. However, a part of the random access configuration information may be associated with all the SS/PBCH blocks in the SS burst set. However, a part of the random access configuration information may be associated with all of the one or multiple CSI-RSs configured. However, a part of the random access configuration information may be associated with one downlink transmission beam (or beam index). However, a part of the random access configuration information may be associated with one SS/PBCH block within the SS burst set. However, a part of the random access configuration information may be associated with one of the one or multiple CSI-RSs configured. However, a part of the random access configuration information may be associated with one downlink transmission beam (or beam index). However, information associated with one SS/PBCH block, one CSI-RS, and/or one downlink transmission beam may include one corresponding SS/PBCH block, one CSI-RS, and/or index information for determining one downlink transmit beam (which may be, for example, an SSB index, a beam index, or a QCL configuration index). However, the random access configuration information may be configured for each SS/PBCH block within the SS burst set, or one random access configuration information common to all the SS/PBCH blocks within the SS burst set may be configured. The terminal apparatus 1 may receive one or multiple pieces of random access configuration information through a downlink signal, and each of the one or multiple pieces of random access configuration information may be associated with an SS/PBCH block (which may be a CSI-RS or a downlink transmission beam). The terminal apparatus 1 may select one of the one or multiple SS/PBCH blocks received (which may be CSI-RSs or downlink transmission beams), and perform the random access procedure by using the random access configuration information associated with the selected SS/PBCH block.

The random access procedure in a case that the terminal apparatus 1 receives message 0 from the base station apparatus 3 is achieved by transmission and reception of multiple messages between the terminal apparatus 1 and the base station apparatus 3.

### Message 0

The base station apparatus 3 allocates one or multiple non-contention based random access preambles to the terminal apparatus 1 by way of downlink dedicated signalling (also referred to as message 0 or Msg0). However, the non-contention based random access preamble may be a random access preamble that is not included in the set notified by broadcast signaling. In a case of transmitting multiple reference signals, the base station apparatus 3 may allocate, to the terminal apparatus 1, multiple non-contention based random access preambles corresponding to respective at least some of the multiple reference signals. Message 0 may be indication information provided by the base station apparatus 3 and indicating, to the terminal apparatus 1, the initiation of the random access procedure. Message 0 may be a handover (HO) command generated by the target base station apparatus 3 and transmitted by the source base station apparatus 3, for handover. Message 0 may be an SCG change command transmitted by the base station apparatus 3 to change the secondary cell group. The handover command and the SCG change command are also referred to as synchronous reconfiguration. This synchronization reconfiguration (reconfiguration with sync or the like) is transmitted in an RRC message. The synchronization reconfiguration is used for an RRC reconfiguration with synchronization to the PCell (handover command and the like) and an RRC reconfiguration with synchronization to the PSCell (SCG change command and the like). Message 0 may be transmitted on the RRC signal and/or the PDCCH. Message 0 transmitted on the PDCCH may be referred to as the PDCCH order. The PDCCH order may be transmitted in DCI in a certain DCI format. Message 0 may include information for allocating a non-contention based random access preamble. Bit information notified in message 0 may include preamble index information, SSB index information, mask index information (which may be referred to as the RACH occasion index), Supplemental UpLink (SUL) information, BWP index information, SRI information, reference signal selection indication information (Reference Signal Selection Indicator, random access configuration selection indication information (Random Access Configuration Selection Indicator), RS type selection indication information, single/multiple message 1 transmission identification information (Single/Multiple Msg.1 Transmission Indicator), and/or TCI. The preamble index information is information indicating one or multiple preamble indexes used for generation of the random access preamble. However, in a case that the preamble index information is a prescribed value, the terminal apparatus 1 may randomly select one of the one or multiple random access preambles available by using the contention based random access procedure. The SSB index information is information indicating an SSB index corresponding to any one of the one or multiple SS/PBCH blocks transmitted by the base station apparatus 3. In a case of receiving message 0, the terminal apparatus 1 determines a group of PRACH occasions to which SSB indexes indicated by the SSB index information are mapped. The SSB index mapped to each PRACH occasion is determined by a PRACH configuration index, a higher layer parameter SB-perRACH-Occasion, and a higher layer parameter cb-preamblePerSSB. The mask index information is information indicating an index of the PRACH occasion available for transmission of the random access preamble. However, the PRACH occasion indicated by the mask index information may be one specific PRACH occasion or may indicate multiple selectable PRACH occasions, or different indexes may indicate either one PRACH occasion or multiple selectable PRACH occasions. The mask index information may be information indicating some PRACH occasions of a group of one or multiple PRACH occasions defined by prach-ConfigurationIndex. However, the mask index information may be information indicating some of the PRACH occasions in the group of PRACH occasions to which specific SSB indexes specified by the SSB index information are mapped.

### Message 1

In a case of receiving message 0, the terminal apparatus 1 transmits the allocated non-contention based random access preamble over the physical random access channel. The transmitted random access preamble may be referred to as message 1 or Msg1. The random access preamble is configured to notify the base station apparatus 3 of information by multiple sequences. For example, in a case that 64 types of sequences are provided, 6-bit information (which may be ra-PreambleIndex or a preamble index) can be indicated to the base station apparatus 3. This information is indicated as a Random Access preamble Identifier, and the terminal apparatus 1 can monitor the random access response (message 2) corresponding to this information to identify message 2 addressed to the terminal apparatus 1 from the base station apparatus 3. The preamble sequence is selected from a preamble sequence set that uses preamble indexes. A procedure for selecting a random access resource (including a time/frequency resource and/or a preamble index) in the MAC layer of the terminal apparatus 1 will be described. The terminal apparatus 1 sets a value for the preamble index (which may be referred to as PREAMBLE_INDEX) of the random access preamble to be transmitted, by using the following procedure. In a case that (1) the random access procedure is initiated in response to the beam failure notification from the lower layer, that (2) the RRC parameter has provided a random access resource (which may be a PRACH occasion) for non-contention based random access for a beam failure recovery request associated with SS/PBCH blocks (also referred to as an SSB) or CSI-RSs, and that (3) one or more SS/PBCH blocks or CSI-RSs have an RSRP exceeding a prescribed threshold, the terminal apparatus 1 selects the SS/PBCH blocks or CSI-RSs having an RSRP exceeding the prescribed threshold, and sets, to the preamble index, ra-PreambleIndex associated with the selected SS/PBCH blocks. In a case that (1) the PDCCH or RRC has provided ra-PreambleIndex, that (2) the value of ra-PreambleIndex is not a value indicating the contention based random access procedure (e.g., 0b000000), and that (3) the RRC does not associate the SS/PBCH blocks or CSI-RSs with the random access resource for non-contention based random access, the terminal apparatus 1 sets ra-PreambleIndex signaled to the preamble index. 0bxxxxxx means a bit sequence allocated in the 6-bit information field. In a case that (1) the RRC has associated the SS/PBCH blocks with the random access resource for non-contention based random access and that (2) one or more SS/PBCH blocks, among the associated SS/PBCH blocks, that have an RSRP exceeding the prescribed threshold, the terminal apparatus 1 selects one of the SS/PBCH blocks having an RSRP exceeding the prescribed threshold, and sets ra-PreambleIndex associated with the selected SS/PBCH block, to the preamble index.

In a case that (1) the RRC has associated the CSI-RSs with the random access resource for non-contention based random access and that (2) one or more CSI-RSs, among the associated CSI-RSs, that have an RSRP exceeding the prescribed threshold, the terminal apparatus 1 selects one of the CSI-RSs having an RSRP exceeding the prescribed threshold, and sets ra-PreambleIndex associated with the selected CSI-RS, to the preamble index. In a case that none of the conditions described above are satisfied, the terminal apparatus 1 performs the contention based random access procedure. In the contention based random access procedure, the terminal apparatus 1 selects SS/PBCH blocks with an SS/PBCH block RSRP exceeding a configured threshold, and selects a preamble group. In a case that the relationship between the SS/PBCH block and the random access preamble is configured, the terminal apparatus 1 randomly selects ra-PreambleIndex from one or multiple random access preambles associated with the selected SS/PBCH blocks and the selected preamble group, and sets the selected ra-PreambleIndex to the preamble index. However, the terminal apparatus 1 may perform the contention based random access procedure in a case that the ra-PreambleIndex indicated by message 0 is a prescribed value (e.g., 0b000000). However, the terminal apparatus 1 may randomly select one of the one or multiple random access preamble indexes available in the contention based random access in a case that ra-PreambleIndex indicated by message 0 is a prescribed value (e.g., 0b000000). The base station apparatus 3 may transmit a resource configuration for each SS/PBCH block and/or a resource configuration for each CSI-RS, to the terminal apparatus 1 through the RRC message. The terminal apparatus 1 receives the resource configuration for each SS/PBCH block and/or the resource configuration for each CSI-RS from the base station apparatus 3 through the RRC message. The base station apparatus 3 may transmit the mask index information and/or the SSB index information to the terminal apparatus 1 through message 0. The terminal apparatus 1 acquires the mask index information and/or the SSB index information from the base station apparatus 3 through message 0. The terminal apparatus 1 may select a reference signal (SS/PBCH block or CSI-RS), based on a certain condition. The terminal apparatus 1 may determine the next available PRACH occasion, based on the mask index information, the SSB index information, the resource configuration indicated by the RRC parameter, and the selected reference signal (SS/PBCH block or CSI-RS). The MAC entity of the terminal apparatus 1 may indicate, to the physical layer, transmission of the random access preamble by using the selected PRACH occasion. However, in a case that the SRI configuration information is indicated by message 0, the terminal apparatus 1 transmits one or multiple random access preambles by using an antenna port and/or an uplink transmission beam corresponding to one or multiple SRS transmission resources indicated in the SRI configuration information.

### Message 2

In a case of receiving message 1, the base station apparatus 3 generates a random access response including an uplink grant for indicating transmission to the terminal apparatus 1, and transmits the generated random access response to the terminal apparatus 1 on the DL-SCH. The random access response may be referred to as message 2 or Msg2. Additionally, the base station apparatus 3 calculates a deviation of transmission timing between the terminal apparatus 1 and the base station apparatus 3 from the received random access preamble, and includes, in message 2, transmission timing adjustment information (Timing Advance Command) for adjusting the deviation. The base station apparatus 3 includes, in message 2, a random access preamble identifier corresponding to the received random access preamble. Additionally, the base station apparatus 3 transmits, on the downlink PDCCH, a RA-RNTI for indicating a random access response addressed to the terminal apparatus 1 having transmitted the random access preamble. The RA-RNTI is determined in accordance with frequency and time position information regarding the physical random access channel on which the random access preamble has been transmitted. In this regard, message 2 (downlink PSCH) may include the index of the uplink transmission beam used for transmission of the random access preamble. Additionally, information for determining an uplink transmission beam used for transmission of the message 3 may be transmitted using the downlink PDCCH and/or message 2 (downlink PSCH). In this regard, the information for determining the uplink transmission beam used for transmission of message 3 may include information indicating a difference (adjustment, correction) from the index of the precoding used for transmission of the random access preamble. The random access response may include a transmit power control command (TPC command) indicating a correction value for the power control adjustment value used for the transmit power for message 3.

Transmission and/or reception of the multiple messages described above allows the terminal apparatus 1 to synchronize with the base station apparatus 3 and to transmit uplink data to the base station apparatus 3.

Now, a downlink path loss reference used for the transmit power of the uplink physical channel and/or the sounding reference signal according to the present embodiment will be described.

Note that the application, to transmit power, of a power adjustment control value obtained by cumulatively calculating correction values obtained from the TPC command received by the terminal apparatus 1 may be referred to as TPC accumulation. Furthermore, the use, by the terminal apparatus 1, of one correction value in an immediately preceding reception without cumulative calculation of correction values obtained from the TPC command may be referred to as TPC absolute, the one correction value being used for transmit power as a power control adjustment value.

Downlink path loss may be calculated by the terminal apparatus 1, based on the transmit power (the transmit power of the base station apparatus 3) for (downlink) path loss reference (e.g., an SS/PBCH block or a CSI-RS) and the RSRP (the measurement result for the path loss reference in the terminal apparatus 1). In this regard, the path loss reference may be a downlink reference signal (for example, an SS block or a CSI-RS) used as a measurement object for the RSRP used for calculating path loss in the terminal apparatus 1 configured by the base station apparatus 3.

The terminal apparatus 1 and the base station apparatus 3 may communicate with each other with no dedicated higher layer configuration being transmitted to the terminal apparatus 1 from the base station apparatus 3. The dedicated higher layer configuration may include zero, one, or multiple reference signals from a set of reference signals to be used for a PUSCH path loss estimation, a set of reference signals to be used for a PUCCH path loss estimation, and a set of reference signals to be used for an SRS path loss estimation.

The base station apparatus 3 may transmit a higher layer configuration pathlossReferenceRSToAddModList to the terminal apparatus 1.

pathlossReferenceRSToAddModList indicates a set of reference signals to be used for the PUSCH path loss estimation. This parameter corresponds to a path loss reference applied to the transmission of the PUSCH described below. The terminal apparatus 1 may receive a higher layer configuration pathlossReferenceRSToAddModList from the base station apparatus 3.

The base station apparatus 3 may include a higher layer configuration pathlossReferenceRS in the configuration information for the PUCCH and transmit the configuration information to the terminal apparatus 1. pathlossReferenceRS included in the configuration information of the PUCCH indicates a set of reference signals to be used for the PUCCH path loss estimation. This parameter corresponds to a path loss reference applied to the transmission of the PUCCH described below. The terminal apparatus 1 may receive, from the base station apparatus 3, the higher layer configuration pathlossReferenceRS included in the configuration information for the PUCCH.

The base station apparatus 3 may include the higher layer configuration pathlossReferenceRS in the SRS configuration information and transmit the configuration information to the terminal apparatus 1. pathlossReferenceRS included in the SRS configuration information indicates a set of reference signals to be used for the SRS path loss estimation. This parameter corresponds to a path loss reference applied to the transmission of the SRS described below. The terminal apparatus 1 may receive the higher layer configuration pathlossReferenceRS included in the SRS configuration information, from the base station apparatus 3.

In a case that, for the path loss reference applied to the transmission of the PUSCH, the base station apparatus 3 has indicated configuration of multiple SS blocks and/or configuration of CSI-RSs to the terminal apparatus 1 through the higher layer signaling (RRC message and/or MAC CE), the information indicating the path loss reference may be information indicating a path loss reference associated with an SRS transmission resource indicated by SRI information indicated from the base station apparatus 3 to the terminal apparatus 1 in an uplink grant, those, of multiple SS blocks and/or CSI-RS, which are configured with an ID of zero, configuration of the multiple SS blocks and/or configuration of the CSI-RSs being indicated by the base station apparatus 3 through the higher layer signaling, information indicating a path loss reference associated with a resource with the minimum ID included in one or multiple PUCCH resources configured by the base station apparatus 3, or information indicating a path loss reference included in the random access response (for example, a reference signal applied as a path loss reference during transmission of message 1 by the terminal apparatus 1). Additionally, in a case that the base station apparatus 3 does not indicate, to the terminal apparatus 1, the configuration of the SS blocks and/or the configuration of the CSI-RSs to the terminal apparatus 1 through the higher layer signaling, the information indicating the path loss reference may be a reference signal (SS block and/or CSI-RS) specified by the terminal apparatus 1 through the random access procedure. In this regard, the random access procedure may be initiated by a specific factor. For example, in a case that the terminal apparatus 1 has not been provided by the base station apparatus 3 with a path loss reference to be applied to the transmission of the PUSCH or before the terminal apparatus 1 is provided with a dedicated higher layer configuration by the base station apparatus 3, the terminal apparatus 1 may calculate a downlink path loss estimation by using the resource for the reference signal from the SS/PBCH block selected by the terminal apparatus 1 through a random access procedure that has been recently performed and that has not been initiated by the PDCCH order triggering the non-contention based random access procedure. The above-described processing may be performed by the terminal apparatus 1 in a case that the downlink path loss estimation used for the transmit power control applied to the transmission of the PUSCH is configured by the higher layer to be performed by using a downlink reference signal for an activated BWP. The base station apparatus 3 may perform power control, based on the assumption that the terminal apparatus 1 has performed the above-described processing. Additionally, the base station apparatus 3 may transmit the higher layer configuration such that the terminal apparatus 1 performs the above-described processing.

In a case that, for the path loss reference applied to the transmission of the PUCCH, the base station apparatus 3 indicates configuration of multiple SS blocks and/or configuration of CSI-RSs to the terminal apparatus 1 through the higher layer signaling (RRC message and/or MAC CE), the information indicating the path loss reference may be information in which the terminal apparatus 1 indicates a path loss reference associated with a PUCCH resource by the base station apparatus 3, those, of multiple SS blocks and/or CSI-RS, which are configured with an ID of zero, configuration of the multiple SS blocks and/or configuration of the CSI-RSs being indicated by the base station apparatus 3 through the higher layer signaling, or information indicating a path loss reference associated with a resource with the minimum ID included in one or multiple PUCCH resources, for a cell for which path loss reference association is configured by the base station apparatus 3 through the higher layer signaling. Additionally, in a case that the base station apparatus 3 does not indicate, to the terminal apparatus 1, the configuration of the SS blocks and/or the configuration of the CSI-RSs to the terminal apparatus 1 through the higher layer signaling, the information indicating the path loss reference may be a reference signal (SS block and/or CSI-RS) specified by the terminal apparatus 1 through the random access procedure. In this regard, the random access procedure may be initiated by a specific factor. For example, in a case that the terminal apparatus 1 has not been provided by the base station apparatus 3 with a path loss reference to be applied to the transmission of the PUCCH or before the terminal apparatus 1 is provided with a dedicated higher layer configuration by the base station apparatus 3, the terminal apparatus 1 may calculate a downlink path loss estimation by using the resource for the reference signal from the SS/PBCH block selected by the terminal apparatus 1 through a random access procedure that has been recently performed and that has not been initiated by the PDCCH order triggering the non-contention based random access procedure. The above-described processing may be performed by the terminal apparatus 1 in a case that the downlink path loss estimation used for the transmit power control applied to the transmission of the PUCCH is configured by the higher layer to be performed by using a downlink reference signal for an activated BWP. The base station apparatus 3 may perform power control, based on the assumption that the terminal apparatus 1 has performed the above-described processing. Additionally, the base station apparatus 3 may transmit the higher layer configuration such that the terminal apparatus 1 performs the above-described processing.

In a case that for the path loss reference applied to the transmission of the SRS, the base station apparatus 3 indicates configuration of multiple SS blocks and/or configuration of CSI-RSs to the terminal apparatus 1 through the higher layer signaling (RRC message and/or MAC CE), the information indicating the path loss reference may be information in which the terminal apparatus 1 indicates a path loss reference associated with an SRS transmission resource by the base station apparatus 3, or information indicating a path loss reference for a cell for which path loss reference association associated with the SRS transmission resource by the base station apparatus 3 through the higher layer signaling. More specifically, in a case that the terminal apparatus 1 is configured with information (panel ID) identifying a panel for the terminal apparatus 1, the information indicating the path loss reference may be information specified by the combination of the panel ID and information identifying the SRS resource configured for the terminal apparatus 1 by the base station apparatus 3 (SRS resource ID). In a case that the terminal apparatus 1 is configured with no information identifying the panel for the terminal apparatus 1 (panel ID), the information indicating the path loss reference may be information specified by the information (SRS resource set ID) identifying the SRS resource set configured for the terminal apparatus 1 by the base station apparatus 3. Additionally, in a case that the base station apparatus 3 does not indicate, to the terminal apparatus 1, the configuration of the SS blocks and/or the configuration of the CSI-RSs to the terminal apparatus 1 through the higher layer signaling, the information indicating the path loss reference may be a reference signal (SS block and/or CSI-RS) specified by the terminal apparatus 1 through the random access procedure. In this regard, the random access procedure may be initiated by a specific factor. For example, in a case that the terminal apparatus 1 has not been provided by the base station apparatus 3 with a path loss reference to be applied to the transmission of the SRS or before the terminal apparatus 1 is provided with a dedicated higher layer configuration by the base station apparatus 3, the terminal apparatus 1 may calculate a downlink path loss estimation by using the resource for the reference signal from the SS/PBCH block selected by the terminal apparatus 1 through a random access procedure that has been recently performed and that has not been initiated by the PDCCH order triggering the non-contention based random access procedure. The above-described processing may be performed by the terminal apparatus 1 in a case that the downlink path loss estimation used for the transmit power control applied to the transmission of the SRS is configured by the higher layer to be performed by using a downlink reference signal for an activated BWP. The base station apparatus 3 may perform power control, based on the assumption that the terminal apparatus 1 has performed the above-described processing. Additionally, the base station apparatus 3 may transmit the higher layer configuration such that the terminal apparatus 1 performs the above-described processing.

The transmit power for the PUSCH and message 3 used by the terminal apparatus 1 is set based on a subcarrier spacing configuration μ, a bandwidth allocated to the PUSCH (the number of resource blocks), reference power for the PUSCH, terminal apparatus-specific power for the PUSCH, a power offset based on a PUSCH modulation scheme, and a downlink path loss compensation factor, downlink path loss, and a correction value for the TPC command for the PUSCH. Note that the subcarrier spacing configuration μ, the reference power for the PUSCH, the terminal apparatus-specific power for the PUSCH, and the downlink path loss compensation factor are configured by the base station apparatus 3 as higher layer configurations. The higher layer configurations may be configured for the terminal apparatus 1 by the base station apparatus 3, for each type of uplink grant, for each cell, or for each uplink subframe set.

The transmit power for the PUCCH used by the terminal apparatus 1 is set based on the subcarrier spacing configuration μ, a bandwidth allocated to the PUCCH (the number of resource blocks), reference power for the PUCCH, terminal apparatus-specific power for the PUCCH, and the downlink path loss compensation factor, a power offset based on a PUCCH format, the downlink path loss, and a correction value for the TPC command for the PUCCH. Note that the subcarrier spacing configuration μ, the reference power for the PUCCH, the terminal apparatus-specific power for the PUCCH, the power offset based on the PUCCH format, and the downlink path loss compensation factor are configured by the base station apparatus 3 as higher layer configurations. The higher layer configurations may be configured for the terminal apparatus 1 by the base station apparatus 3 for each cell group.

The transmit power for the SRS used by the terminal apparatus 1 is set based on the subcarrier spacing configuration μ, a bandwidth allocated to the SRS (the number of resource blocks), reference power for the SRS, and the downlink path loss compensation factor, the downlink path loss, and a correction value for the TPC command for the SRS. Note that the subcarrier spacing configuration μ, the reference power for the SRS, and the downlink path loss compensation factor are configured by the base station apparatus 3 as higher layer configurations. The higher layer configurations may be configured for the terminal apparatus 1 by the base station apparatus 3, for each type of uplink grant, for each cell, or for each uplink subframe set.

For the PUSCH, the PUCCH, and the SRS, the terminal apparatus 1 adjusts power, based on the TPC commands corresponding to the respective physical channels.

The base station apparatus 3 may configure, for the terminal apparatus 1, whether the TPC accumulation is performed for each cell, for each physical channel, for each subframe set, or for each SRS resource set. Additionally, as the TPC accumulation for the SRS, TPC accumulation for the PUSCH may be used by the terminal apparatus 1.

In this way, the terminal apparatus 1 can appropriately set the uplink transmit power, based on the path loss reference.

Configurations of apparatuses according to the present embodiment will be described below.

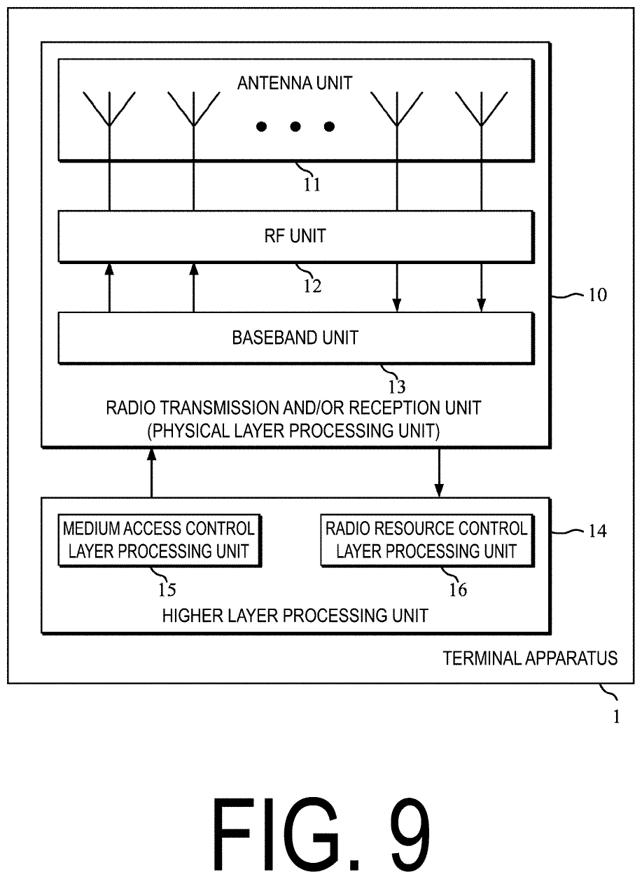

FIG. 9 is a schematic block diagram illustrating a configuration of the terminal apparatus 1 according to the present embodiment. As illustrated, the terminal apparatus 1 is configured to include a radio transmission and/or reception unit 10 and a higher layer processing unit 14. The radio transmission and/or reception unit 10 is configured to include an antenna unit 11, a Radio Frequency (RF) unit 12, and a baseband unit 13. The higher layer processing unit 14 includes a medium access control layer processing unit 15 and a radio resource control layer processing unit 16. The radio transmission and/or reception unit 10 is also referred to as a transmitter, a receiver, a monitor unit, or a physical layer processing unit. The higher layer processing unit 14 is also referred to as a measurement unit, a selection unit, or a control unit.

The higher layer processing unit 14 outputs uplink data (that may be referred to as transport block) generated by a user operation or the like, to the radio transmission and/or reception unit 10. The higher layer processing unit 14 performs a part or all of the processing of the Medium Access Control (MAC) layer, the Packet Data Convergence Protocol (PDCP) layer, the Radio Link Control (RLC) layer, and the Radio Resource Control (RRC) layer. The higher layer processing unit 14 may function to select one of one or multiple reference signals, based on measurement values of the one or multiple reference signals. The higher layer processing unit 14 may function to select, from one or multiple PRACH occasions, a PRACH occasion associated with the selected one reference signal. The higher layer processing unit 14 may function to specify one of one or multiple indexes configured by a higher layer (e.g., an RRC layer) and to set the resultant index as a preamble index, in a case that the bit information included in the information received by the radio transmission and/or reception unit 10 and indicating the initiation of the random access procedure is a prescribed value. The higher layer processing unit 14 may function to specify one of one or multiple indexes configured by the RRC to be an index associated with the selected reference signal, and to set the resultant index as a preamble index. The higher layer processing unit 14 may function to determine the next available PRACH occasion, based on the received information (e.g., SSB index information and/or mask index information). The higher layer processing unit 14 may function to select the SS/PBCH block, based on the received information (e.g., SSB index information). The higher layer processing unit may function to determine a downlink path loss reference used for the transmit power for the uplink physical channel (PUSCH, PUCCH) and/or the sounding reference signal by using information indicating a path loss reference indicated by the higher layer signaling, and/or SRI information indicated by the uplink grant (for example, information indicating a path loss reference associated with the SRS transmission resource), and/or information of one or multiple PUCCH resources configured (e.g., information indicating a path loss reference associated with a resource with the minimum ID), and/or information of a reference signal applied as a path loss reference during transmission of message 1, and/or information of a reference number determined by the random access procedure. More specifically, in a case that the terminal apparatus 1 is configured with the panel ID, the information indicating the path loss reference may be information specified by a combination of the SRS resource ID and the panel ID. Additionally, in a case that the terminal apparatus 1 is not configured with the panel ID, the information indicating the path loss reference may be information specified by the SRS resource set ID. The higher layer processing unit may function to determine the subcarrier spacing configuration μ, the reference power for the uplink physical channel (PUSCH, PUCCH) and/or the sounding reference signal, the terminal apparatus-specific power for the uplink physical channel (PUSCH, PUCCH) and/or the sounding reference signal, all these parameters being configured by the higher layer signaling, and the downlink path loss compensation factor.

FIG. 8 illustrates an example of panel ID related configurations and SRS resource set configurations. Two configurations related to the panel ID are provided. The two configurations include panel ID related configuration #0 including SRS resources #0, #2, and #4, and panel ID related configuration including SRS resources #1, #5, and #6. Three configurations related to the SRS resource set are provided. The three configurations include SRS resource set configuration #0 including SRS resources #0, #2, and #4, SRS resource set configuration #1 including SRS resources #1, #5, and #6, and SRS resource set configuration #2 including SRS resource #3. Information indicating the path loss reference to be applied to SRS resource #0 is specified as information associated with SRS resource #0 in panel ID related configuration #0. The base station apparatus 3 may indicate, to the terminal apparatus 1 by DCI or MAC CE or RRC signaling, which of synchronization signal block #1 and CSI reference signal #1 included in panel ID related configuration #0 is applied to SRS resource #0. Additionally, SRS resource #3 is not configured with information related to the panel ID. In this case, information indicating the path loss reference applied to SRS resource #3 is specified as information associated with SRS resource #3 in SRS resource set configuration #2. The base station apparatus 3 may indicate, to the terminal apparatus 1 by DCI or MAC CE or RRC signaling, which of the reference signals included in SRS resource set configuration #2 is applied.

The medium access control layer processing unit 15 included in the higher layer processing unit 14 performs processing of the Medium Access Control layer (MAC layer). The medium access control layer processing unit 15 controls transmission of a scheduling request, based on various types of configuration information/parameters managed by the radio resource control layer processing unit 16.

The radio resource control layer processing unit 16 included in the higher layer processing unit 14 performs processing of the Radio Resource Control layer (RRC layer). The radio resource control layer processing unit 16 manages various types of configuration information/parameters of the terminal apparatus 1. The radio resource control layer processing unit 16 sets various types of configuration information/parameters based on a higher layer signaling received from the base station apparatus 3. In other words, the radio resource control layer processing unit 16 sets the various configuration information/parameters based on the information indicating the various configuration information/parameters received from the base station apparatus 3.

The radio transmission and/or reception unit 10 performs processing of the physical layer, such as modulation, demodulation, coding, and decoding. The radio transmission and/or reception unit 10 demultiplexes, demodulates, and decodes a signal received from the base station apparatus 3, and outputs the information resulting from the decoding to the higher layer processing unit 14. The radio transmission and/or reception unit 10 generates a transmit signal by modulating and coding data, and performs transmission to the base station apparatus 3. The radio transmission and/or reception unit 10 may function to receive one or multiple reference signals in a certain cell. The radio transmission and/or reception unit 10 may function to receive information specifying one or multiple PRACH occasions (e.g., SSB index information and/or mask index information). The radio transmission and/or reception unit 10 may function to receive a signal including indication information indicating the initiation of the random access procedure. The radio transmission and/or reception unit 10 may function to receive information for receiving information specifying a prescribed index. The radio transmission and/or reception unit 10 may function to receive information specifying the index of the random access preamble. The radio transmission and/or reception unit 10 may function to transmit the random access preamble on the PRACH occasion determined by the higher layer processing unit 14.

The RF unit 12 converts (down converts) a signal received via the antenna unit 11 into a baseband signal by orthogonal demodulation and removes unnecessary frequency components. The RF unit 12 outputs a processed analog signal to the baseband unit.

The baseband unit 13 converts the analog signal input from the RF unit 12 into a digital signal. The baseband unit 13 removes a portion corresponding to a Cyclic Prefix (CP) from the converted digital signal, performs a Fast Fourier Transform (FFT) on the signal from which the CP has been removed, and extracts a signal in the frequency domain.

The baseband unit 13 generates an OFDM symbol by performing Inverse Fast Fourier Transform (IFFT) on the data, adds CP to the generated OFDM symbol, generates a baseband digital signal, and converts the baseband digital signal into an analog signal. The baseband unit 13 outputs the converted analog signal to the RF unit 12.

The RF unit 12 removes unnecessary frequency components from the analog signal input from the baseband unit 13 through a low-pass filter, up converts the analog signal into a signal of a carrier frequency, and transmits the up converted signal via the antenna unit 11. Also, the RF unit 12 amplifies power. Additionally, the RF unit 12 may function to determine transmit power for the uplink physical channel (PUSCH, PUCCH) and/or the sounding reference signal transmitted in the serving cell. The RF unit 12 is also referred to as a transmit power controller. The transmit power control unit may function to adjust the transmit power for the uplink signal by using the TPC command and/or the parameters configured by the path loss reference specified by the higher layer processing unit and/or the higher layer signaling (the subcarrier spacing configuration μ, the reference power for the uplink physical channel (PUSCH, PUCCH) and/or the sounding reference signal, and the terminal apparatus-specific power for the uplink physical channel (PUSCH, PUCCH)), and/or the downlink path loss compensation factor.

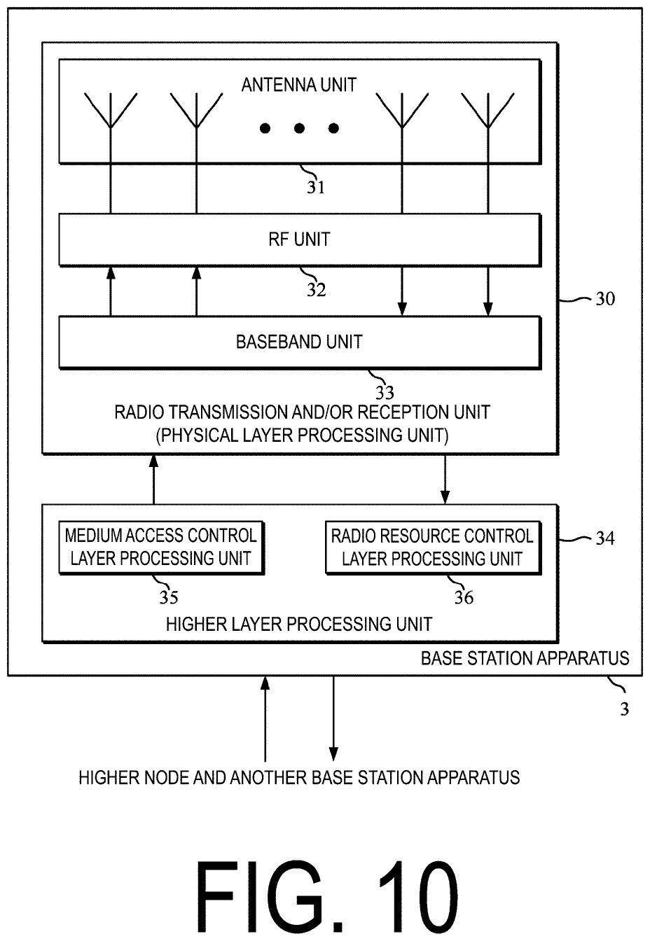

FIG. 10 is a schematic block diagram illustrating the configuration of the base station apparatus 3 according to the present embodiment. As illustrated, the base station apparatus 3 is configured to include a radio transmission and/or reception unit 30 and a higher layer processing unit 34. The radio transmission and/or reception unit 30 is configured to include an antenna unit 31, an RF unit 32, and a baseband unit 33. The higher layer processing unit 34 includes a medium access control layer processing unit 35 and a radio resource control layer processing unit 36. The radio transmission and/or reception unit 30 is also referred to as a transmitter, a receiver, a monitor unit, or a physical layer processing unit. A controller controlling operations of the units based on various conditions may be separately provided. The higher layer processing unit 34 is also referred to as a terminal control unit.

The higher layer processing unit 34 performs processing for some or all of the Medium Access Control (MAC) layer, the Packet Data Convergence Protocol (PDCP) layer, the Radio Link Control (RLC) layer, and the Radio Resource Control (RRC) layer. The higher layer processing unit 34 may function to specify one of one or multiple reference signals, based on the random access preamble received by the radio transmission and/or reception unit 30. The higher layer processing unit 34 may determine, from at least the SSB index information and the mask index information, the PRACH occasion to monitor the random access preamble.

The medium access control layer processing unit 35 included in the higher layer processing unit 34 performs processing of the MAC layer. The medium access control layer processing unit 35 performs processing associated with a scheduling request, based on various types of configuration information/parameters managed by the radio resource control layer processing unit 36.

The radio resource control layer processing unit 36 included in the higher layer processing unit 34 performs processing of the RRC layer. The radio resource control layer processing unit 36 generates, or acquires from a higher node, downlink data (transport block) allocated on a physical downlink shared channel, system information, an RRC message, a MAC Control Element (CE), and the like, and outputs the generated or acquired data to the radio transmission and/or reception unit 30. Further, the radio resource control layer processing unit 36 manages various types of configuration information/parameters for each terminal apparatus 1. The radio resource control layer processing unit 36 may set various types of configuration information/parameters for each terminal apparatus 1 via higher layer signals. In other words, the radio resource control layer processing unit 36 transmits/broadcasts information indicating various types of configuration information/parameters. The radio resource control layer processing unit 36 may transmit/report information for specifying a configuration of multiple reference signals in a certain cell.

In a case that the base station apparatus 3 transmits the RRC message, the MAC CE, and/or the PDCCH to the terminal apparatus 1, and the terminal apparatus 1 performs processing, based on the reception, the base station apparatus 3 performs processing (control of the terminal apparatus 1 and the system) assuming that the terminal apparatus is performing the above-described processing. In other words, the base station apparatus 3 sends, to the terminal apparatus 1, the RRC message, MAC CE, and/or PDCCH intended to cause the terminal apparatus to perform the processing based on the reception.

The radio transmission and/or reception unit 30 functions to transmit one or multiple reference signals. The radio transmission and/or reception unit 30 may function to receive a signal including a beam failure recovery request transmitted from the terminal apparatus 1. The radio transmission and/or reception unit 30 may function to transmit, to the terminal apparatus 1, information specifying one or multiple PRACH occasions (e.g., SSB index information and/or mask index information). The radio transmission and/or reception unit 30 may function to transmit information specifying a prescribed index. The radio transmission and/or reception unit 30 may function to transmit information specifying the index of the random access preamble. The radio transmission and/or reception unit 30 may function to monitor the random access preamble on the PRACH occasion specified by the higher layer processing unit 34. In addition, some of the functions of the radio transmission and/or reception unit 30 are similar to the corresponding functions of the radio transmission and/or reception unit 10, and thus description of these functions is omitted. Note that in a case that the base station apparatus 3 is connected to one or multiple transmission reception points 4, some or all of the functions of the radio transmission and/or reception unit 30 may be included in each of the transmission reception points 4.

Further, the higher layer processing unit 34 transmits (transfers) or receives control messages or user data between the base station apparatuses 3 or between a higher network apparatus (MME, S-GW (Serving-GW)) and the base station apparatus 3. Although, in FIG. 10, other constituent elements of the base station apparatus 3, a transmission path of data (control information) between the constituent elements, and the like are omitted, it is apparent that the base station apparatus 3 is provided with multiple blocks, as constituent elements, including other functions necessary to operate as the base station apparatus 3. For example, a radio resource management layer processing unit or an application layer processing unit reside in the higher layer processing unit 34. The higher layer processing unit 34 may also function to configure multiple scheduling request resources corresponding to respective multiple reference signals transmitted from the radio transmission and/or reception unit 30.

Note that “units” in the drawing refer to constituent elements to realize the functions and the procedures of the terminal apparatus 1 and the base station apparatus 3, which are also represented by the terms such as a section, a circuit, a constituting apparatus, a device, a unit, and the like.

Each of the units having the reference signs 10 to 16 included in the terminal apparatus 1 may be implemented as a circuit. Each of the units having the reference signs 30 to 36 included in the base station apparatus 3 may be implemented as a circuit.

(1) More specifically, a communication method according to a first aspect of the present invention is a communication method for a terminal apparatus, the communication method including: receiving a higher layer configuration including a parameter for a sounding reference signal and a parameter to be applied to transmit power control; and transmitting the sounding reference signal, wherein one or multiple path loss reference reference signal parameters are included in the parameter to be applied to the transmit power control, at least one of a panel ID, a sounding reference signal resource set ID, or a sounding reference signal resource ID is included in the parameter for the sounding reference signal, a path loss reference reference signal is identified by using a combination of the panel ID and the sounding reference signal resource ID, a downlink path loss estimation is calculated by using the path loss reference reference signal, the transmit power control is performed on the sounding reference signal.

(2) In the communication method according to a second aspect of the present invention, the spatial relation information is identified by the sounding reference signal resource set ID in a case that the path loss reference reference signal does not include, in the higher layer configuration received, information related to the panel ID, and a downlink path loss estimation is calculated by using the path loss reference reference signal, power control is performed, and the sounding reference signal is transmitted.

(3) A communication method according to a third aspect of the present invention is a communication method for a base station apparatus, the communication method including: transmitting, to a terminal apparatus, a higher layer configuration including a parameter for a sounding reference signal and a parameter to be applied to transmit power control; and receiving the sounding reference signal transmitted, wherein one or multiple path loss reference reference signal parameters are included in the parameter to be applied to the transmit power control, at least one of a panel ID, a sounding reference signal resource set ID, or a sounding reference signal resource ID is included in the parameter for the sounding reference signal, a path loss reference reference signal is identified by a combination of the panel ID and the sounding reference signal resource ID, a downlink path loss estimation is calculated by using the path loss reference reference signal, and power control is performed on the sounding reference signal.

(4) A terminal apparatus according to a fourth aspect of the present invention is a terminal apparatus including: a receiver configured to receive a higher layer configuration including a parameter for a sounding reference signal and a parameter to be applied to transmit power control; and a transmitter configured to transmit the sounding reference signal, wherein one or multiple path loss reference reference signal parameters are included in the parameter to be applied to the transmit power control, at least one of a panel ID, a sounding reference signal resource set ID, or a sounding reference signal resource ID is included in the parameter for the sounding reference signal, a path loss reference reference signal is identified by using a combination of the panel ID and the sounding reference signal resource ID, a downlink path loss estimation is calculated by using the path loss reference reference signal, and power control is performed on the sounding reference signal.

(5) A base station apparatus according to a fifth aspect of the present invention is a base station apparatus including: a transmitter configured to transmit, to a terminal apparatus, a higher layer configuration including a parameter for a sounding reference signal and a parameter to be applied to transmit power control; and a receiver configured to receive the sounding reference signal transmitted, wherein one or multiple path loss reference reference signal parameters are included in the parameter to be applied to the transmit power control, at least one of a panel ID, a sounding reference signal resource set ID, or a sounding reference signal resource ID is included in the parameter for the sounding reference signal, a path loss reference reference signal is identified by a combination of the panel ID and the sounding reference signal resource ID, a downlink path loss estimation is calculated by using the path loss reference reference signal, and power control is performed on the sounding reference signal.

(6) An integrated circuit according to a sixth aspect of the present invention is an integrated circuit mounted in a terminal apparatus, the integrated circuit including: a receiving unit configured to receive a higher layer configuration including a parameter for a sounding reference signal and a parameter to be applied to transmit power control; and a transmitting unit configured to transmit a sounding reference signal, wherein one or multiple path loss reference reference signal parameters are included in the parameter to be applied to the transmit power control, at least one of a panel ID, a sounding reference signal resource set ID, or a sounding reference signal resource ID is included in the parameter for the sounding reference signal, a path loss reference reference signal is identified by using a combination of the panel ID and the sounding reference signal resource ID, a downlink path loss estimation is calculated by using the path loss reference reference signal, and power control is performed on the sounding reference signal.

(7) An integrated circuit according to a seventh aspect of the present invention is an integrated circuit mounted in a base station apparatus, the integrated circuit including: a transmitting unit configured to transmit, to a terminal apparatus, a higher layer configuration including a parameter for a sounding reference signal and a parameter to be applied to transmit power control; and a receiving unit configured to receive the sounding reference signal transmitted, wherein one or multiple path loss reference reference signal parameters are included in the parameter to be applied to the transmit power control, at least one of a panel ID, a sounding reference signal resource set ID, and a sounding reference signal resource ID is included in the parameters for the sounding reference signal, a path loss reference reference signal is identified by a combination of the panel ID and the sounding reference signal resource ID, a downlink path loss estimation is calculated by using the path loss reference reference signal, and power control is performed on the sounding reference signal.

A program running on an apparatus according to the present invention may serve as a program that controls a Central Processing Unit (CPU) and the like to cause a computer to operate in such a manner as to realize the functions of the above-described embodiment according to the present invention. Programs or the information handled by the programs are temporarily stored in a volatile memory such as a Random Access Memory (RAM), a non-volatile memory such as a flash memory, a Hard Disk Drive (HDD), or any other storage device system.

Note that a program for realizing the functions of the embodiments according to the present invention may be recorded in a computer-readable recording medium. It may be implemented by causing a computer system to read and execute the program recorded on this recording medium. It is assumed that the “computer system” refers to a computer system built into the apparatuses, and the computer system includes an operating system and hardware components such as a peripheral device. Furthermore, the “computer-readable recording medium” may be any of a semiconductor recording medium, an optical recording medium, a magnetic recording medium, a medium dynamically retaining the program for a short time, or any other computer readable recording medium.

Furthermore, each functional block or various characteristics of the apparatuses used in the above-described embodiment may be implemented or performed on an electric circuit, for example, an integrated circuit or multiple integrated circuits. An electric circuit designed to perform the functions described in the present specification may include a general purpose processor, a digital signal processor (DSP), an application specific integrated circuit (ASIC), a field programmable gate array (FPGA), or other programmable logic devices, discrete gates or transistor logic, discrete hardware components, or a combination thereof. The general purpose processor may be a microprocessor or may be a processor, a controller, a micro-controller, or a state machine of known type, instead. The above-mentioned electric circuit may include a digital circuit, or may include an analog circuit. Furthermore, in a case that with advances in semiconductor technology, a circuit integration technology appears that replaces the present integrated circuits, it is also possible to use a new integrated circuit based on the technology according to one or multiple aspects of the present invention.

Note that, in the embodiments according to the present invention, an example has been described in which the present invention is applied to a communication system including a base station apparatus and a terminal apparatus, but the present invention can also be applied in a system in which terminals communicate as in the case of Device to Device (D2D).

Note that the invention of the present application is not limited to the above-described embodiments. Although apparatuses have been described as an example in the embodiment, the invention of the present application is not limited to these apparatuses, and is applicable to a stationary type or a non-movable type electronic apparatus installed indoors or outdoors such as a terminal apparatus or a communication apparatus, for example, an AV device, a kitchen device, a cleaning or washing machine, an air-conditioning device, office equipment, a vending machine, and other household appliances.

Although, the embodiments of the present invention have been described in detail above referring to the drawings, the specific configuration is not limited to the embodiments and includes, for example, design changes within the scope not depart from the gist of the present invention. Furthermore, various modifications are possible within the scope of claims of the present invention, and embodiments that are made by suitably combining technical means disclosed according to the different embodiments are also included in the technical scope of the present invention. Furthermore, a configuration in which elements described in the respective embodiments and having mutually the same effects, are substituted for one another is also included.

1. A communication method for a terminal apparatus, the communication method comprising:
receiving a higher layer configuration including a parameter for a sounding reference signal and a parameter to be applied to transmit power control; and
transmitting the sounding reference signal, wherein
one or multiple path loss reference reference signal parameters are included in the parameter to be applied to the transmit power control,
at least one of a sounding reference signal resource set ID or a sounding reference signal resource ID is included in the parameter for the sounding reference signal,
a first path loss reference reference signal is identified by using the sounding reference signal resource set ID, and
a downlink path loss estimation is calculated by using the first path loss reference reference signal and the transmit power control is performed on the sounding reference signal by using the downlink path loss estimation.

2. A communication method, comprising:
in a case that a higher layer configuration received includes information related to a panel ID, identifying a second path loss reference reference signal by using a combination of the panel ID and the sounding reference signal resource ID, and
calculating a downlink path loss estimation by using the second path loss reference reference signal and performing transmit power control on the sounding reference signal by using the downlink path loss estimation.

3. A communication method for a base station apparatus, the communication method comprising:
transmitting, to a terminal apparatus, a higher layer configuration including a parameter for a sounding reference signal and a parameter to be applied to transmit power control; and
receiving the sounding reference signal transmitted from the terminal apparatus, wherein
one or multiple path loss reference reference signal parameters are included in the parameter to be applied to the transmit power control,
at least one of a sounding reference signal resource set ID or a sounding reference signal resource ID is included in the parameter for the sounding reference signal, and
the sounding reference signal is a signal obtained by calculating, by the terminal apparatus, a downlink path loss estimation by using a first path loss reference reference signal identified based on the sounding reference signal resource set ID and performing, by the terminal apparatus, the transmit power control by using the downlink path loss estimation.

4. A terminal apparatus comprising:
a receiver configured to receive a higher layer configuration including a parameter for a sounding reference signal and a parameter to be applied to transmit power control; and
a transmitter configured to transmit the sounding reference signal, wherein
one or multiple path loss reference reference signal parameters are included in the parameter to be applied to the transmit power control,
at least one of a sounding reference signal resource set ID or a sounding reference signal resource ID is included in the parameter for the sounding reference signal,
a first path loss reference reference signal is identified by using a sounding reference signal resource set ID, and
a downlink path loss estimation is calculated by using the first path loss reference reference signal and the transmit power control is performed on the sounding reference signal by using the downlink path loss estimation.

5. A base station apparatus comprising:
a transmitter configured to transmit, to a terminal apparatus, a higher layer configuration including a parameter for a sounding reference signal and a parameter to be applied to transmit power control; and
a receiver configured to receive the sounding reference signal transmitted from the terminal apparatus, wherein
one or multiple path loss reference reference signal parameters are included in the parameter to be applied to the transmit power control,
at least one of a sounding reference signal resource set ID or a sounding reference signal resource ID is included in the parameter for the sounding reference signal, and
the sounding reference signal is a signal obtained by calculating, by the terminal apparatus, a downlink path loss estimation by using a first path loss reference reference signal identified based on the sounding reference signal resource set ID and performing, by the terminal apparatus, the transmit power control by using the downlink path loss estimation.

6. An integrated circuit mounted in a terminal apparatus, the integrated circuit comprising:
a receiving unit configured to receive a higher layer configuration including a parameter for a sounding reference signal and a parameter to be applied to transmit power control; and
a transmitting unit configured to transmit the sounding reference signal, wherein
one or multiple path loss reference reference signal parameters are included in the parameter to be applied to the transmit power control,
at least one of a sounding reference signal resource set ID or a sounding reference signal resource ID is included in the parameter for the sounding reference signal,
a first path loss reference reference signal is identified by using a sounding reference signal resource set ID, and
a downlink path loss estimation is calculated by using the first path loss reference reference signal and the transmit power control is performed on the sounding reference signal by using the downlink path loss estimation.

7. An integrated circuit mounted in a base station apparatus, the integrated circuit comprising:
a transmitting unit configured to transmit, to a terminal apparatus, a higher layer configuration including a parameter for a sounding reference signal and a parameter to be applied to transmit power control; and
a receiving unit configured to receive the sounding reference signal transmitted from the terminal apparatus, wherein
one or multiple path loss reference reference signal parameters are included in the parameter to be applied to the transmit power control,
at least one of a sounding reference signal resource set ID or a sounding reference signal resource ID is included in the parameter for the sounding reference signal, and
the sounding reference signal is a signal obtained by calculating, by the terminal apparatus, a downlink path loss estimation by using a first path loss reference reference signal identified based on the sounding reference signal resource set ID and performing, by the terminal apparatus, the transmit power control by using the downlink path loss estimation.
